(19) United States
(12) Patent Application Publication
(10) Pub. No.: US 2024/0288755 A1
(43) Pub. Date: Aug. 29, 2024

(54) OPTICAL SYSTEM, IMAGE PROJECTION APPARATUS, AND IMAGING APPARATUS

(71) Applicant: Panasonic Intellectual Property Management Co., Ltd., Osaka (JP)

(72) Inventor: Takuya Imaoka, Kanagawa (JP)

(21) Appl. No.: 18/653,197

(22) Filed: May 2, 2024

Related U.S. Application Data
(63) Continuation of application No. PCT/JP2022/026320, filed on Jun. 30, 2022.

(30) Foreign Application Priority Data
Nov. 12, 2021 (JP) 2021-185123
Nov. 12, 2021 (JP) 2021-185125

(51) Int. Cl. G03B 21/14; G02B 13/02; G02B 13/16; G02B 27/02; G02B 27/18

(52) U.S. Cl. CPC G03B 21/142; G02B 13/02; G02B 13/16; G02B 27/025; G02B 27/18

(57) ABSTRACT

The present disclosure is directed to an optical system having a reduction conjugate point on a reduction side and a magnification conjugate point on a magnification side that are optically conjugate with each other, the optical system including an imaging optical system having a plurality of lens elements that are rotationally symmetric with respect to an optical axis, and an aperture stop, wherein a first rectangular region at the reduction conjugate point and a second rectangular region at the magnification conjugate point have an optically conjugate image forming relation, a normal line of the second rectangular region is inclined at a tilt angle of 10 degrees or more with respect to the optical axis, and a tilt correction plate CP that corrects defocus in the first rectangular region or the second rectangular region is positioned on the reduction side of the aperture stop between the reduction conjugate point and the magnification conjugate point.

### CROSS-REFERENCE TO RELATED APPLICATIONS

This application is a continuation of International Patent Application No. PCT/JP2022/026320, filed on Jun. 30, 2022, which claims the benefit of Japanese Patent Application No. 2021-185123, filed on Nov. 12, 2021, and the benefit of Japanese Patent Application No. 2021-185125, filed on Nov. 12, 2021, the contents all of which are incorporated herein by reference.

### TECHNICAL FIELD

The present disclosure relates to an optical system in which an optical axis is inclined with respect to the normal line of an image plane. The present disclosure also relates to an image projection apparatus and an imaging apparatus using such an optical system.

### BACKGROUND ART

Patent Documents 1 to 3 disclose a laser scanning projector that two-dimensionally scans laser light using an optical scanning means, such as a galvanometer mirror or a MEMS mirror. In such an oblique projection method, there is a challenge to reduce trapezoidal distortion and field curvature that occur on the screen as much as possible. In Patent Document 1, a projection optical system 7 includes a first reflecting mirror 7, a refractive lens 5, and a second reflecting mirror 6. In Patent Document 2, a scanning optical system 106 includes two scanning mirrors 106a and 106b, each consisting of a rotationally asymmetric reflecting surface. In Patent Document 3, a scanning optical system 106 includes a first scanning mirror 106a, a second scanning mirror 106b, and one scanning lens 106c.

### PRIOR ART

[Patent Document 1] wo 2009/057522 A1
[Patent Document 2] JP 2005-234157 A
[Patent Document 3] JP 2006-178346 A

### SUMMARY OF THE INVENTION

The present disclosure provides an optical system that can reduce field curvature as much as possible even when the optical axis is inclined with respect to the normal line of the image plane. The present disclosure also provides an image projection apparatus and an imaging apparatus using such an optical system.

An aspect of the present disclosure is directed to an optical system having a reduction conjugate point on a reduction side and a magnification conjugate point on a magnification side that are optically conjugate with each other, the optical system including an imaging optical system having a plurality of lens elements that are rotationally symmetric with respect to an optical axis, and an aperture stop,
wherein a first rectangular region at the reduction conjugate point and a second rectangular region at the magnification conjugate point have an optically conjugate image forming relation,
a normal line of the second rectangular region is inclined at a tilt angle of 10 degrees or more with respect to the optical axis, and
a tilt correction plate that corrects defocus in the first rectangular region or the second rectangular region is positioned on the reduction side of the aperture stop between the reduction conjugate point and the magnification conjugate point.

The tilt correction plate may be configured to satisfy the following expression (10), where two end points of the first rectangular region in a meridional plane including the normal line and the optical axis are defined as points A and B:

$$pb - pa > 0 \qquad ( 10 )$$

$$pa = ( nd - 1 ) \times ( 1 / ra 1 - 1 / ra 2 ) \qquad ( 10 A )$$

$$pb = ( nd - 1 ) \times ( 1 / rb 1 - 1 / rb 2 ) \qquad ( 10 B )$$

where nd is a refractive index of the tilt correction plate, ra1 is a partial radius of curvature in the meridional plane at a point a1 where a straight line parallel to the optical axis passes through the point A and intersects with the first plane of the tilt correction plate, ra2 is a partial radius of curvature in the meridional plane at a point a2 where a straight line parallel to the optical axis passes through the point A and intersects with the second plane of the tilt correction plate, rb1 is a partial radius of curvature in the meridional plane at a point b1 where a straight line parallel to the optical axis passes through the point B and intersects with the first plane of the tilt correction plate, and rb2 is a partial radius of curvature in the meridional plane at a point b2 where a straight line parallel to the optical axis passes through the point B and intersects with the second surface of the tilt correction plate.

Further, an aspect of the present disclosure is directed to an optical system having a reduction conjugate point on a reduction side and a magnification conjugate point on a magnification side that are optically conjugate with each other, the optical system including an imaging optical system having a plurality of lens elements that are rotationally symmetric with respect to an optical axis, and an aperture stop, wherein a first rectangular region at the reduction conjugate point and a second rectangular region at the magnification conjugate point have an optically conjugate image forming relation,
a normal line of the second rectangular region is inclined at a tilt angle of 10 degrees or more with respect to the optical axis, and
a tilt correction plate that corrects defocus in the first rectangular region or the second rectangular region is positioned on the reduction side of the aperture stop between the reduction conjugate point and the magnification conjugate point,
wherein the tilt correction plate is configured to satisfy the following expression (11), where two end points of the first rectangular region in a meridional plane including the normal line and the optical axis are defined as points A and B:

$$α 1 A - α 1 B > 0 \qquad ( 11 A )$$

$$α 2 A - α 2 B > 0 \qquad ( 11 B )$$

where α1A is an angle at which a straight line connecting a point a1 (where a straight line parallel to the optical axis passes through the point A and intersects with the first surface of the tilt correction plate) and the center of the partial radius of curvature at the point a1 intersects with the optical axis, α1B is an angle at which a straight line connecting a point b1 (where a straight line parallel to the optical axis passes through the point B and intersects with the first surface of the tilt correction plate) and the center of the partial radius of curvature at the point b1 intersects with the optical axis, α2A is an angle at which a straight line connecting a point a2 (where a straight line parallel to the optical axis passes through the point A and intersects with the second surface of the tilt correction plate) and the center of the partial radius of curvature at the point a2 intersects with the optical axis, and α2B is as an angle at which a straight line connecting a point b2 (where a straight line parallel to the optical axis passes through the point B and intersects with the second surface of the tilt correction plate CP) and the center of the partial radius of curvature at the point b2 intersects with the optical axis.

Further, an image projection apparatus according to another aspect of the present disclosure includes the above-described optical system and an image forming element that generates an image to be projected through the optical system onto a screen.

Still further, an imaging apparatus according to another aspect of the present disclosure includes the above-described optical system and an imaging element that receives an optical image formed by the optical system to convert the optical image into an electrical image signal.

In the optical system according to the present disclosure, field curvature can be reduced as much as possible even when the optical axis is inclined with respect to the normal line of the image plane.

### BRIEF DESCRIPTION OF THE DRAWINGS

FIG. 1 is a layout diagram showing an optical path at a wide-angle end in a zoom lens system of example 1 for an object distance of 1080 mm.

FIGS. 1A to 1D are explanatory diagrams each illustrating an outline of an oblique projection system in which a normal line of a screen is inclined at a predetermined tilt angle with respect to an optical axis. FIG. 1A illustrates a case with a tilt angle of 10 degrees, FIG. 1B illustrates a case with a tilt angle of 20 degrees, FIG. 1C illustrates a case with a tilt angle of 30 degrees, and FIG. 1D illustrates a case with a tilt angle of 40 degrees.

FIG. 2A to 2E are partial perspective views illustrating different displacement states of a tilt correction plate according to the present disclosure. FIG. 2A illustrates a case with a tilt angle of 0 degrees, FIG. 2B illustrates a case with a tilt angle of 10 degrees, FIG. 2C illustrates a case with a tilt angle of 20 degrees, FIG. 2D illustrates a case with a tilt angle of 30 degrees, and FIG. 2E illustrates a case with a tilt angle of 40 degrees.

FIG. 3 is a layout diagram illustrating an optical system according to Example 1.

FIG. 4 is diagram illustrating lateral aberration on the wide side at a shift angle of 10 degrees in the optical system according to Example 1.

FIG. 5 is diagram illustrating lateral aberration on the wide side at a shift angle of 20 degrees in the optical system according to Example 1.

FIG. 6 is diagram illustrating lateral aberration on the wide side at a shift angle of 30 degrees in the optical system according to Example 1.

FIG. 7 is diagram illustrating lateral aberration on the wide side at a shift angle of 40 degrees in the optical system according to Example 1.

FIG. 8 is diagram illustrating lateral aberration on the telephoto side at a shift angle of 10 degrees in the optical system according to Example 1.

FIG. 9 is diagram illustrating lateral aberration on the telephoto side at a shift angle of 20 degrees in the optical system according to Example 1.

FIG. 10 is diagram illustrating lateral aberration on the telephoto side at a shift angle of 30 degrees in the optical system according to Example 1.

FIG. 11 is diagram illustrating lateral aberration on the telephoto side at a shift angle of 40 degrees in the optical system according to Example 1.

FIG. 12 is a layout diagram illustrating an optical system according to Example 2.

FIG. 13 is diagram illustrating lateral aberration on the wide side at a shift angle of 10 degrees in the optical system according to Example 2.

FIG. 14 is diagram illustrating lateral aberration on the wide side at a shift angle of 20 degrees in the optical system according to Example 2.

FIG. 15 is diagram illustrating lateral aberration on the wide side at a shift angle of 30 degrees in the optical system according to Example 2.

FIG. 16 is diagram illustrating lateral aberration on the wide side at a shift angle of 40 degrees in the optical system according to Example 2.

FIG. 17 is diagram illustrating lateral aberration on the telephoto side at a shift angle of 10 degrees in the optical system according to Example 2.

FIG. 18 is diagram illustrating lateral aberration on the telephoto side at a shift angle of 20 degrees in the optical system according to Example 2.

FIG. 19 is diagram illustrating lateral aberration on the telephoto side at a shift angle of 30 degrees in the optical system according to Example 2.

FIG. 20 is diagram illustrating lateral aberration on the telephoto side at a shift angle of 40 degrees in the optical system according to Example 2.

FIG. 21 is a layout diagram illustrating an optical system according to Example 3.

FIG. 22 is diagram illustrating lateral aberration on the wide side at a shift angle of 10 degrees in the optical system according to Example 3.

FIG. 23 is diagram illustrating lateral aberration on the wide side at a shift angle of 20 degrees in the optical system according to Example 3.

FIG. 24 is diagram illustrating lateral aberration on the wide side at a shift angle of 30 degrees in the optical system according to Example 3.

FIG. 25 is diagram illustrating lateral aberration on the wide side at a shift angle of 40 degrees in the optical system according to Example 3.

FIG. 26 is diagram illustrating lateral aberration on the telephoto side at a shift angle of 10 degrees in the optical system according to Example 3.

FIG. 27 is diagram illustrating lateral aberration on the telephoto side at a shift angle of 20 degrees in the optical system according to Example 3.

FIG. 28 is diagram illustrating lateral aberration on the telephoto side at a shift angle of 30 degrees in the optical system according to Example 3.

FIG. 29 is diagram illustrating lateral aberration on the telephoto side at a shift angle of 40 degrees in the optical system according to Example 3.

FIG. 30 is a layout diagram illustrating an optical system according to Example 4.

FIG. 31 is a diagram illustrating lateral aberration at a shift angle of 40 degrees in the optical system according to Example 4.

FIG. 32 is an explanatory diagram illustrating partial radii of curvature on the first surface and the second surface of the tilt correction plate.

FIG. 33A is an explanatory diagram illustrating paths of various light rays passing through the tilt correction plate.

FIG. 33B is an explanatory diagram illustrating partial radii of curvature on the first surface and the second surface of the tilt correction plate.

FIG. 34A is an explanatory diagram illustrating a situation in which the optical axis is inclined by the folding mirror MR.

FIG. 34B is an explanatory diagram illustrating how defocus and coma aberration in the second rectangular region caused by the inclination of the optical axis can be reduced using a relation between the Y-direction optical power of the meridional plane and the X-direction optical power of the sagittal plane.

FIG. 34C is an explanatory diagram illustrating partial radii of curvature on the first surface and the second surface of the tilt correction plate.

FIG. 35 is a block diagram showing an example of the image projection apparatus according to the present disclosure.

FIG. 36 is a block diagram showing an example of the imaging apparatus according to the present disclosure.

### DETAILED DESCRIPTION

Hereinafter, embodiments are described in detail with reference to the drawings as appropriate. However, unnecessarily detailed descriptions may be omitted. For example, detailed descriptions of well-known items or redundant descriptions of substantially the same configurations may be omitted. This is to prevent the following description from being unnecessarily redundant and to facilitate understanding by those skilled in the art.

It should be noted that the applicant provides the accompanying drawings and the following description for those skilled in the art to fully understand the present disclosure, and it is not intended to limit the subject matter described in the claims thereby.

Each example of an optical system according to the present disclosure is described below. In each example, described is an example in which the optical system is used in a projector (an example of an image projection apparatus) that projects onto a screen image light of an original image S obtained by spatially modulating incident light using an image forming element, such as liquid crystal or digital micromirror device (DMD), based on an image signal. In other words, the optical system according to the present disclosure can be used for magnifying the original image S on the image forming element arranged on the reduction side to project the image onto the screen (not shown), which is arranged on an extension line on the magnification side. However, a projection surface is not limited to the screen. Examples of the projection surface includes walls, ceilings, floors, windows, etc. in houses, stores, or vehicles and airplanes used as means for transportation.

Further, the optical system according to the present disclosure can also be used for collecting light emitted from an object located on the extension line on the magnification side to form an optical image of the object on an imaging surface of an imaging element arranged on the reduction side.

### First Embodiment

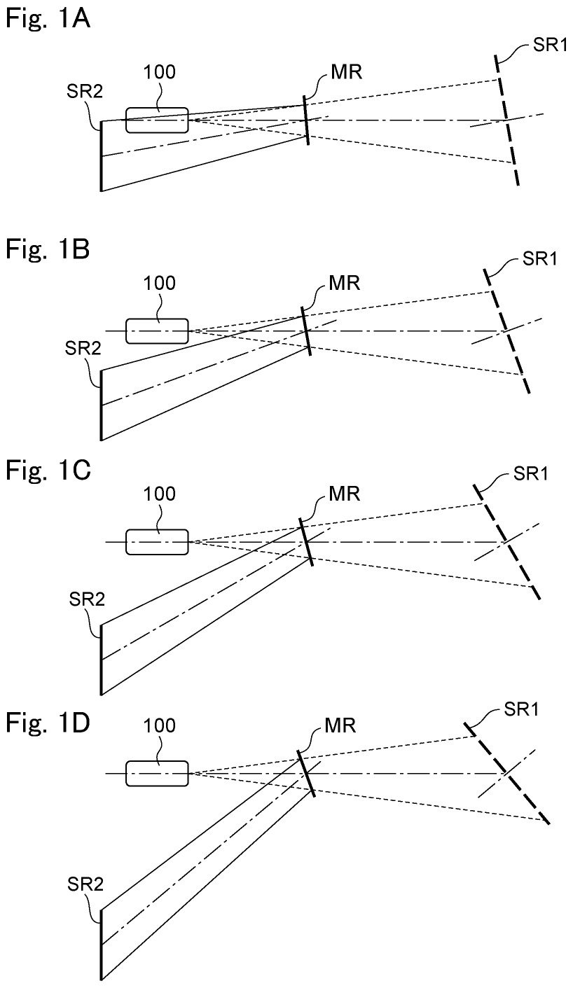

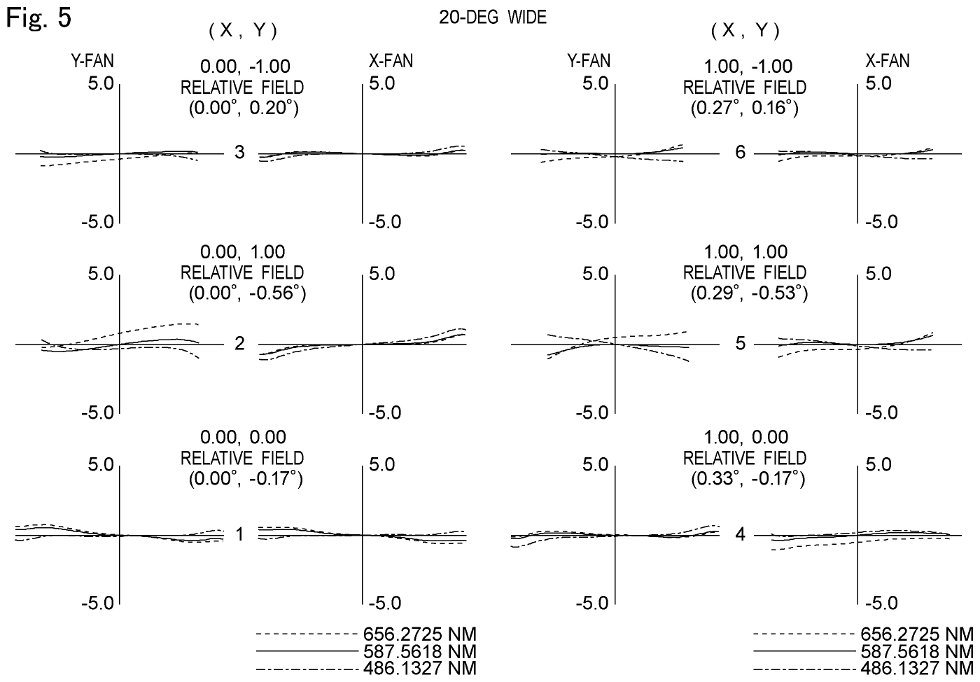

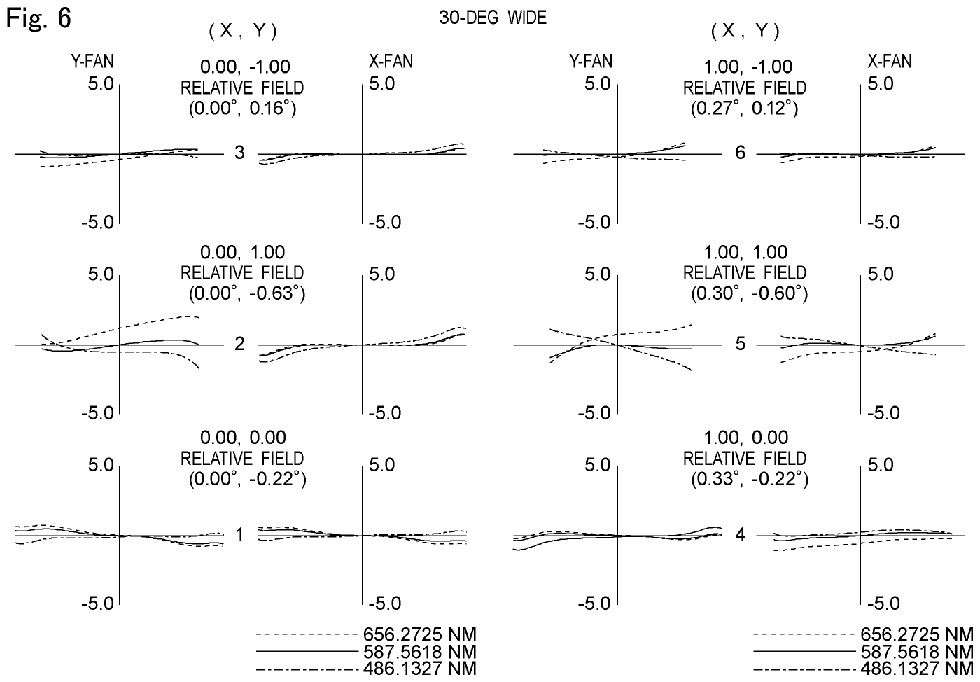

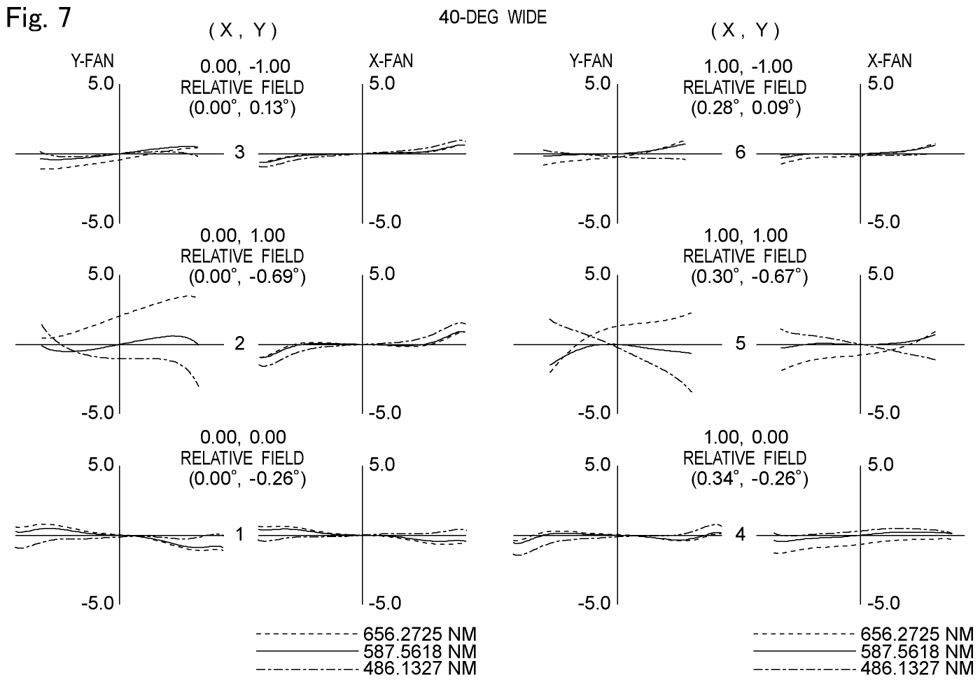

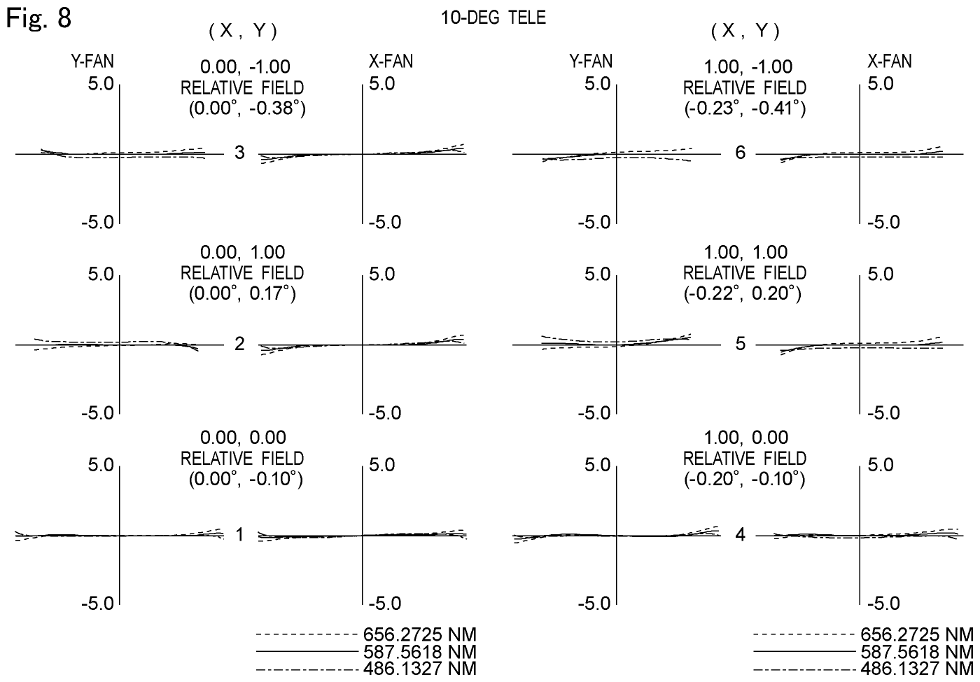

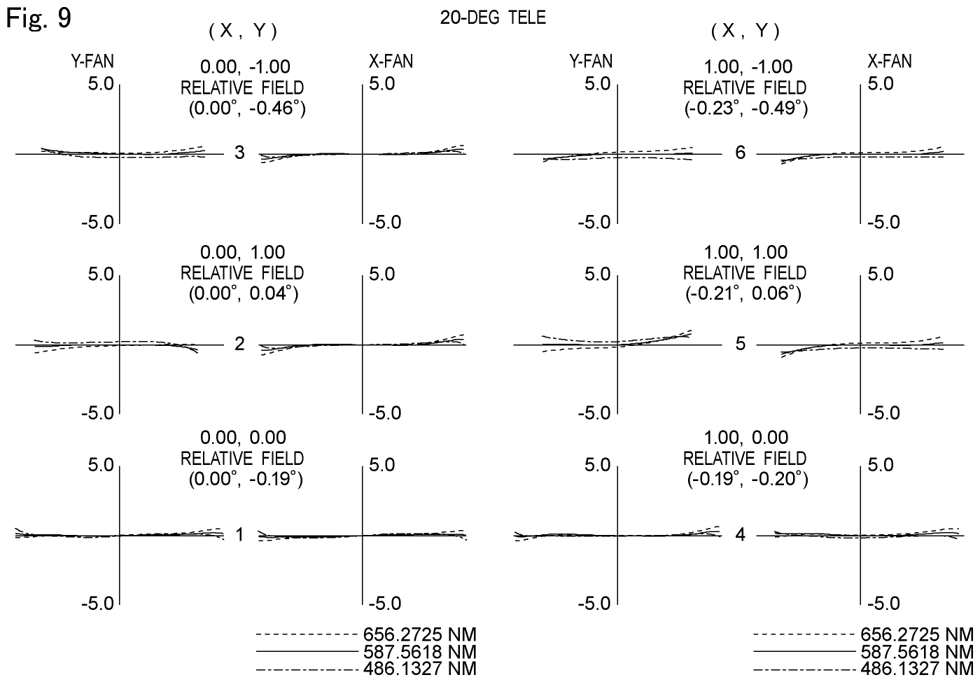

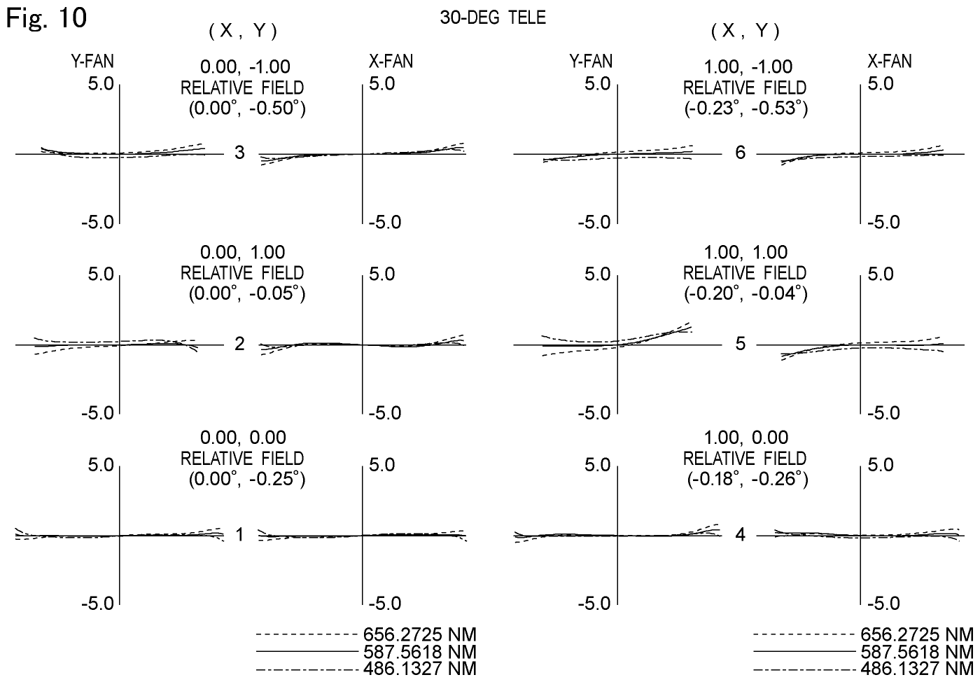

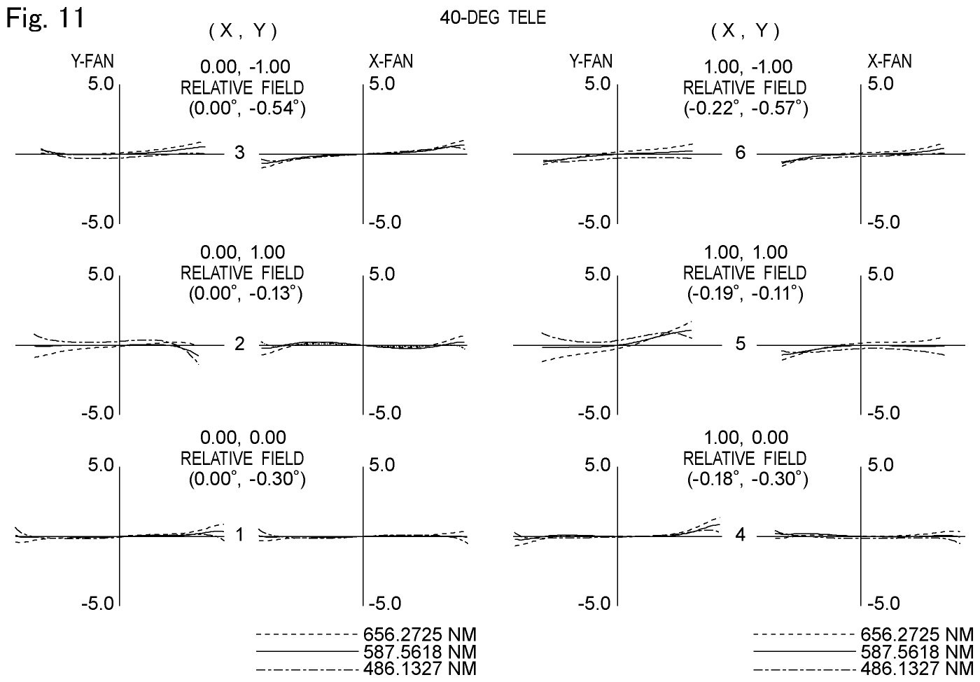

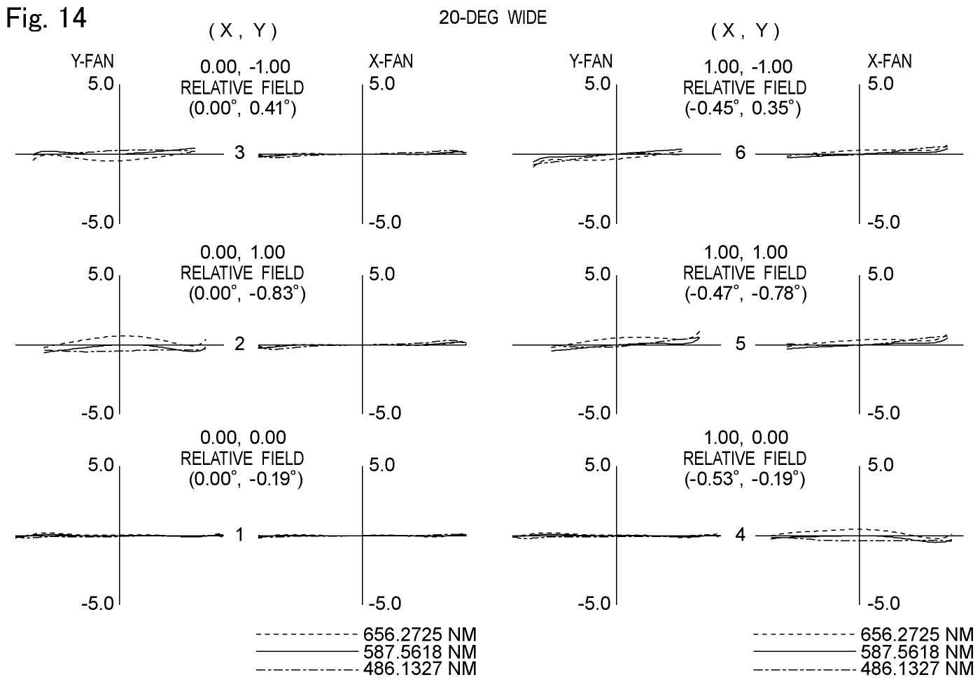

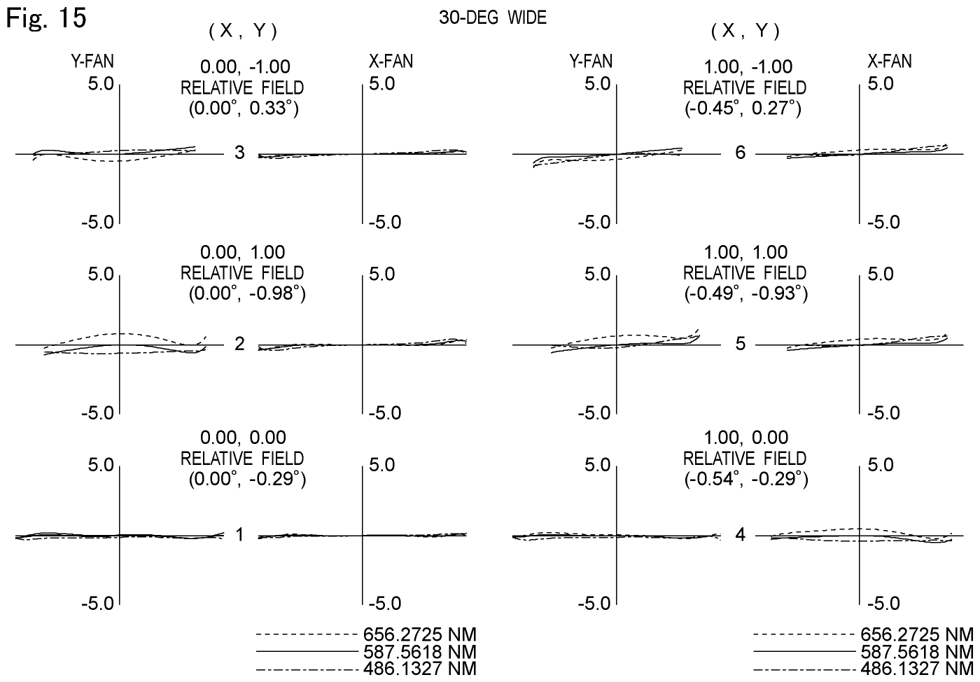

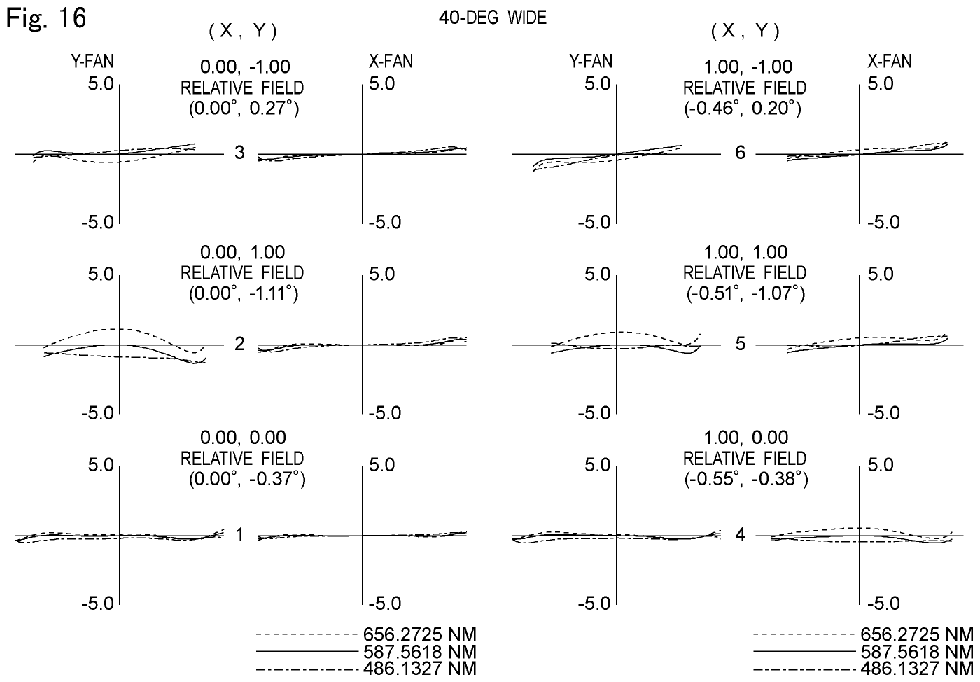

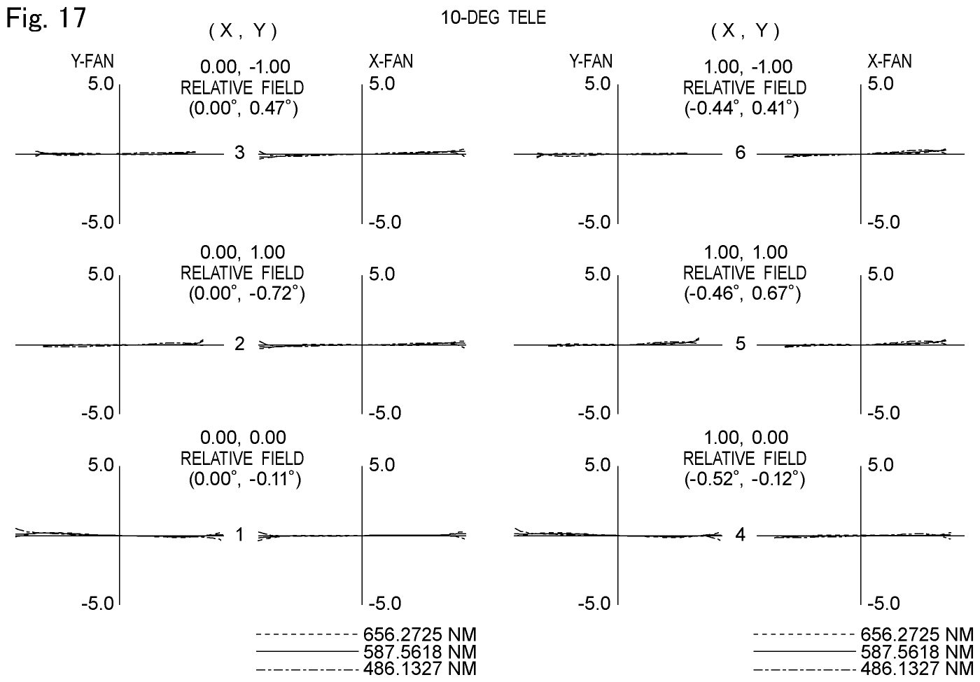

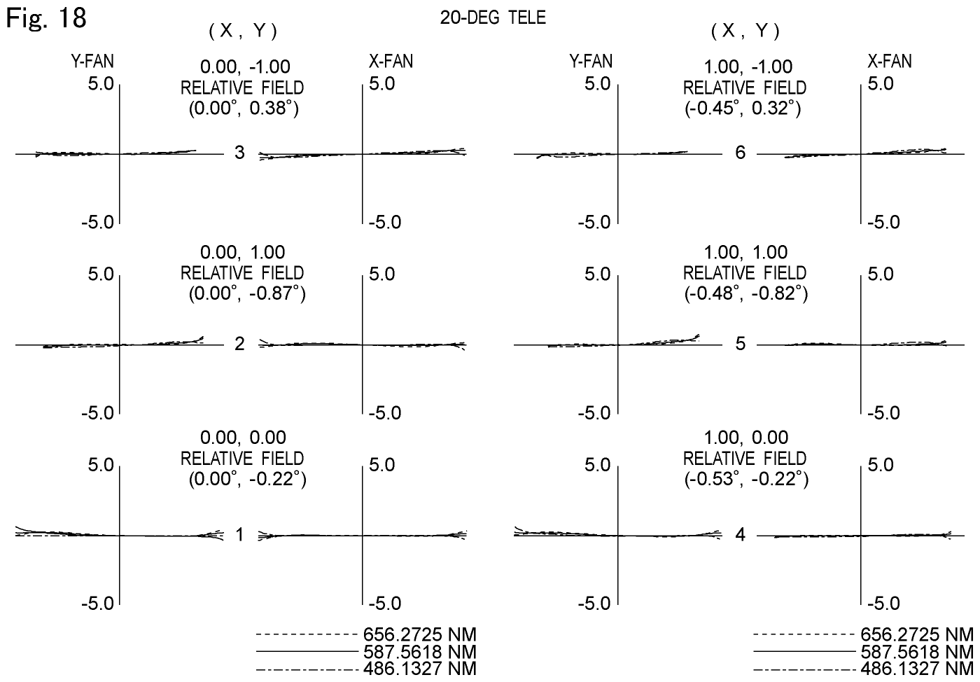

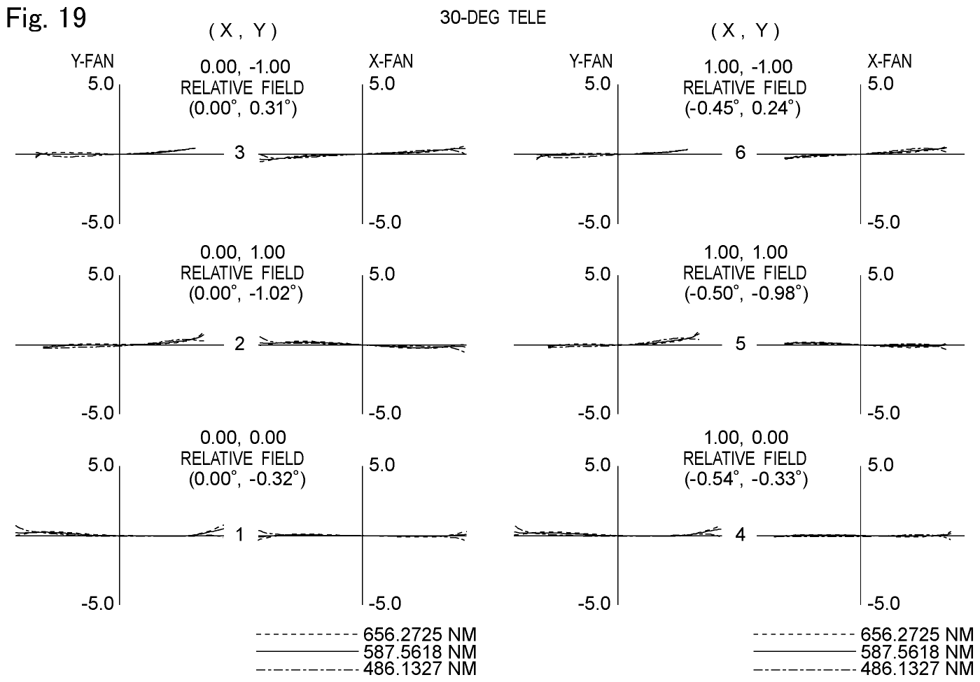

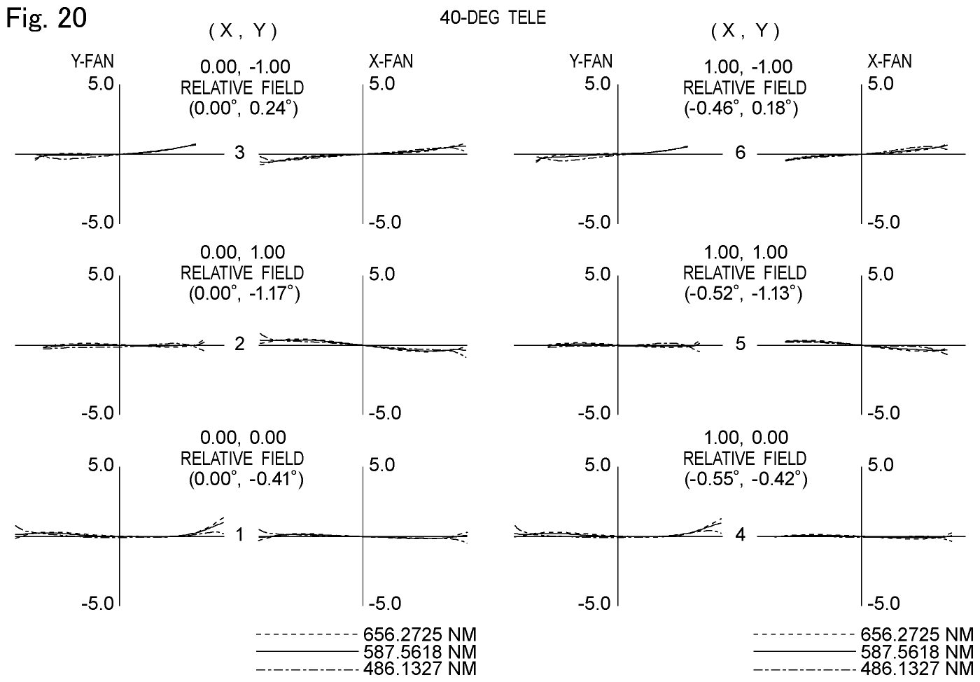

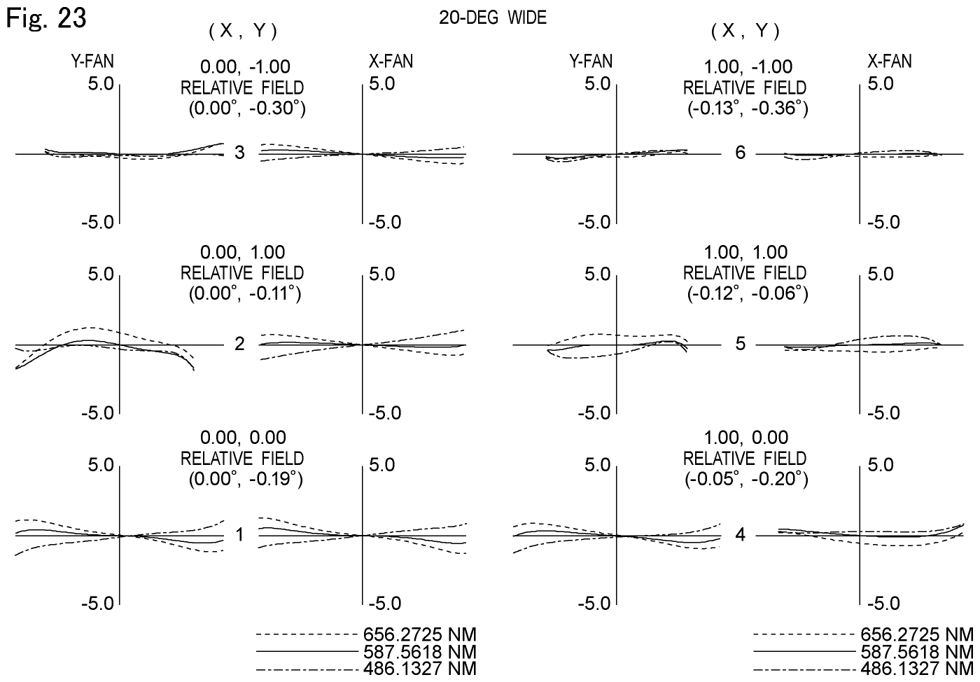

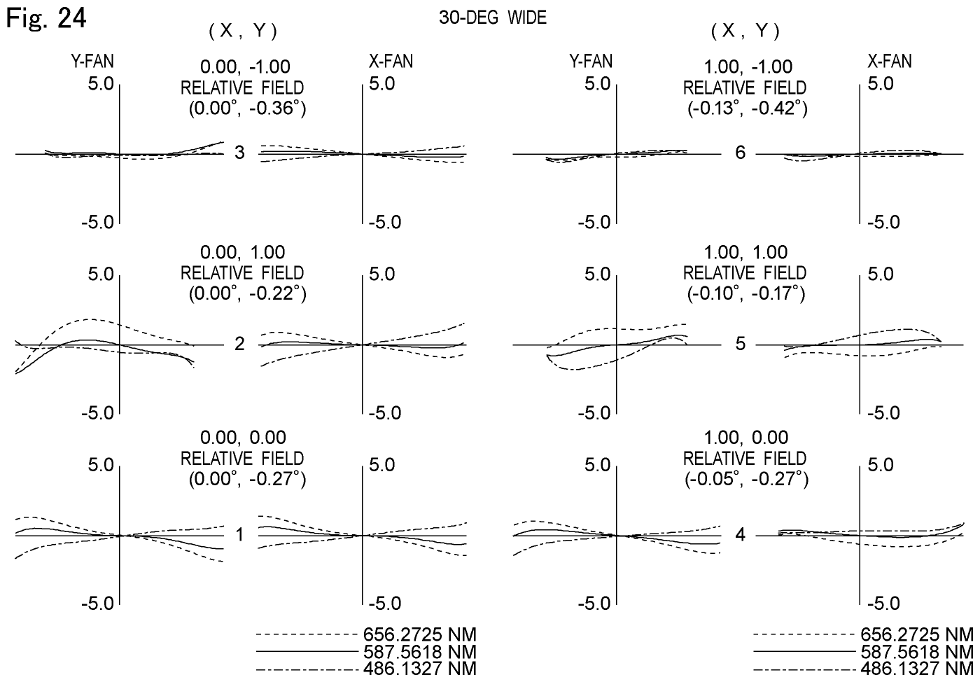

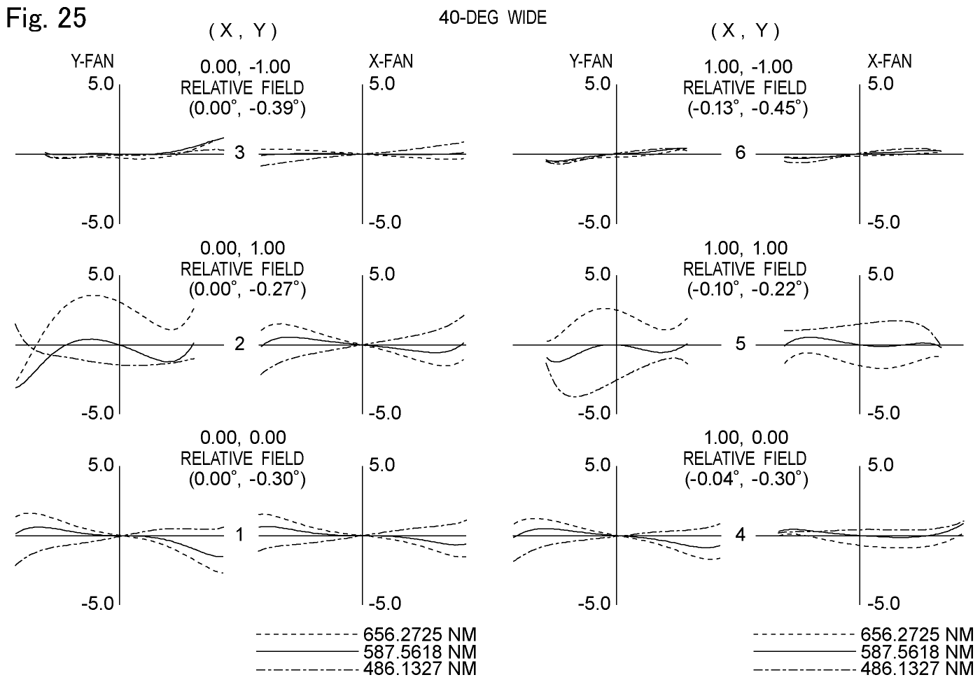

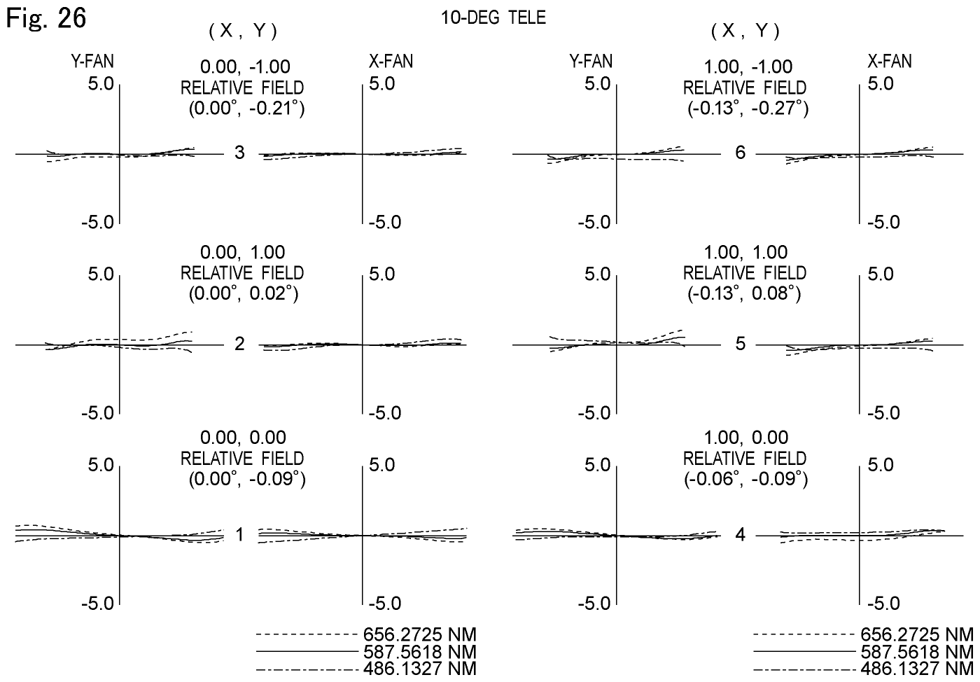

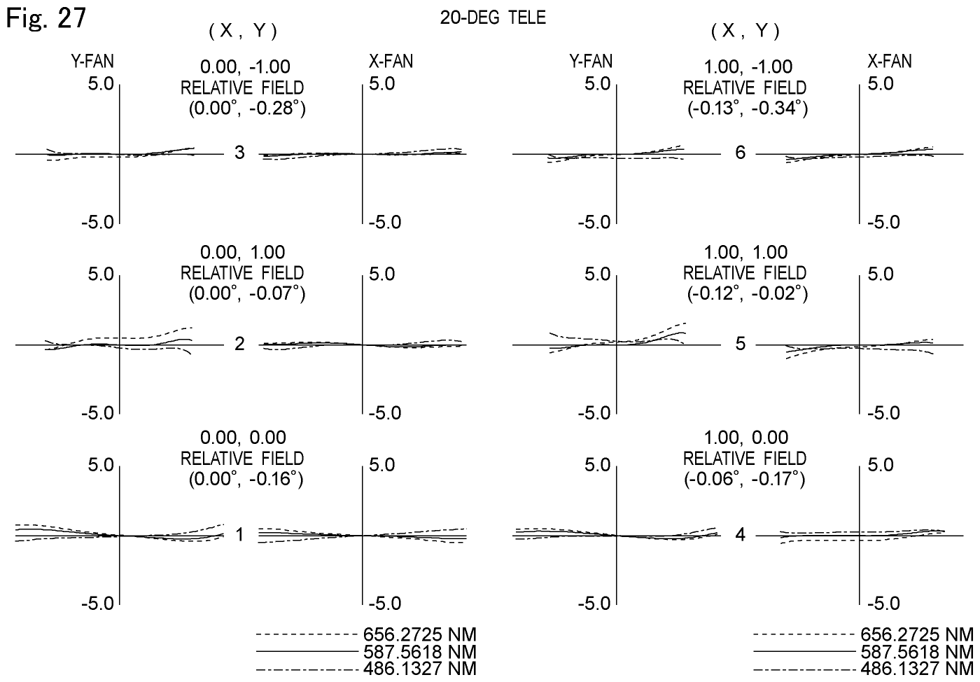

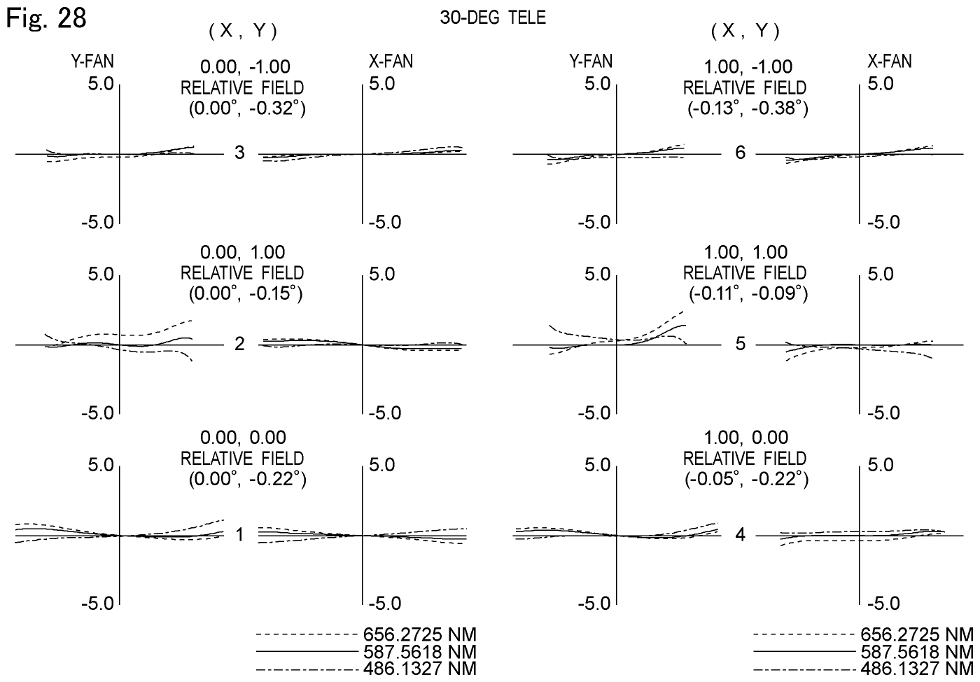

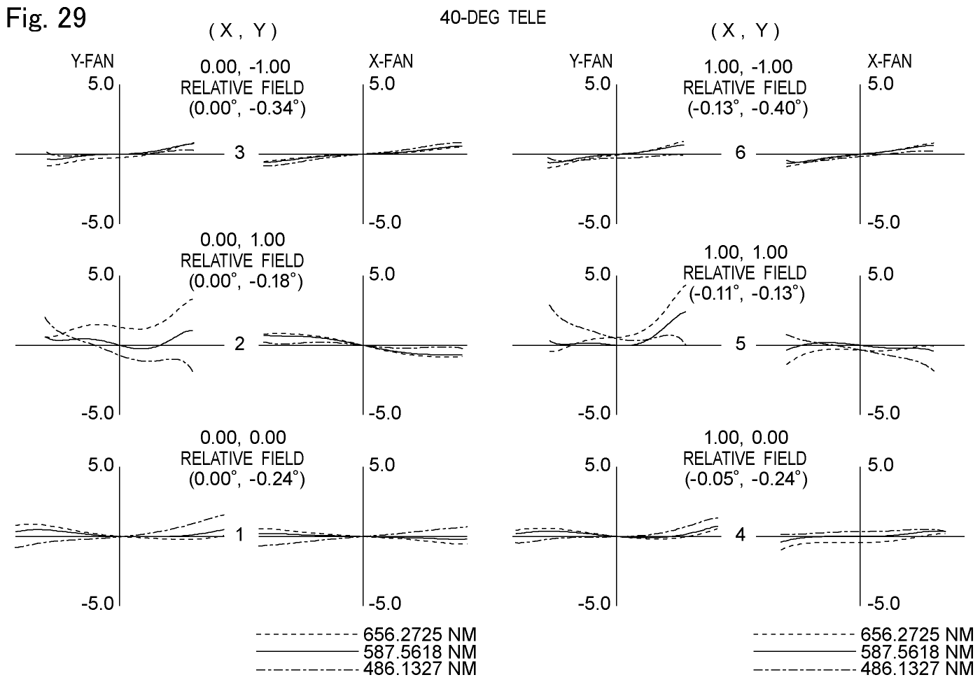

Hereinafter, an optical system according to a first embodiment of the present disclosure will be described below with reference to FIGS. 1 to 36.

FIGS. 1A to 1D are explanatory diagrams each illustrating an outline of an oblique projection system in which a normal line of a screen is inclined at a predetermined tilt angle with respect to an optical axis. FIG. 1A illustrates a case with a tilt angle of 10 degrees, FIG. 1B illustrates a case with a tilt angle of 20 degrees, FIG. 1C illustrates a case with a tilt angle of 30 degrees, and FIG. 1D illustrates a case with a tilt angle of 40 degrees. Here, an image projection apparatus using an oblique projection system will be described as an example, but the same applies to an imaging apparatus using an oblique imaging system in which a traveling direction of a light ray is inverted.

As illustrated in FIGS. 1A to 1D, an optical axis (one-dot chain line) of an image projection apparatus 100 is set in a horizontal direction parallel to a floor or a ceiling, for example, and a screen SR1 is inclined at a predetermined tilt angle. A folding mirror MR inclined at a predetermined angle may be installed between the image projection apparatus 100 and the screen SR1, and in this case, a screen SR2 is installed perpendicular to the floor or the ceiling.

In FIG. 1A, the optical axis intersects with the normal line of the screen SR1 at a tilt angle of 10 degrees. When the folding mirror MR inclined at an angle of 5 degrees is installed, the optical axis also intersects with the normal line of the screen SR2 at a tilt angle of 10 degrees. In FIG. 1B, the optical axis intersects with the normal line of the screen SR1 at a tilt angle of 20 degrees. When the folding mirror MR inclined at an angle of 10 degrees is installed, the optical axis also intersects with the normal line of the screen SR2 at a tilt angle of 20 degrees. In FIG. 1C, the optical axis intersects with the normal line of the screen SR1 at a tilt angle of 30 degrees. When the folding mirror MR inclined at an angle of 15 degrees is installed, the optical axis also intersects with the normal line of the screen SR2 at a tilt angle of 30 degrees. In FIG. 1D, the optical axis intersects with the normal line of the screen SR1 at a tilt angle of 40 degrees. When the folding mirror MR inclined at an angle of 20 degrees is installed, the optical axis also intersects with the normal line of the screen SR2 at a tilt angle of 40 degrees.

FIG. 2A to 2E are partial perspective views illustrating different displacement states of a tilt correction plate according to the present disclosure. FIG. 2A illustrates a case with a tilt angle of 0 degrees, FIG. 2B illustrates a case with a tilt angle of 10 degrees, FIG. 2C illustrates a case with a tilt angle of 20 degrees, FIG. 2D illustrates a case with a tilt angle of 30 degrees, and FIG. 2E illustrates a case with a tilt angle of 40 degrees. The tilt correction plate CP is made of a plate curved in a free-form surface shape having, for example, a length of 100 mm and a width of 60 mm. The tilt correction plate CP is used as a part of an optical system of the image projection apparatus 100, and can be positioned at any position between a reduction conjugate point and a magnification conjugate point of the optical system. Here, a case where the tilt correction plate CP is positioned between an optical element P (having an optical power of zero) closest to the reduction side and a lens element L close to the optical element P will be exemplified.

In the case with the tilt angle of 0 degrees illustrated in FIG. 2A, the optical axis is parallel to the normal line of the screen, resulting in a front projection system instead of the oblique projection system. The case with the tilt angle of 10 degrees illustrated in FIG. 2B corresponds to FIG. 1A, and the tilt correction plate CP is shifted closer to the optical axis than in FIG. 2A. The case with the tilt angle of 20 degrees illustrated in FIG. 2C corresponds to FIG. 1B, and the tilt correction plate CP is shifted closer to the optical axis than in FIG. 2B. The case with the tilt angle of 30 degrees illustrated in FIG. 2D corresponds to FIG. 1C, and the tilt correction plate CP is further shifted closer to the optical axis than in FIG. 2C. The case with the tilt angle of 40 degrees illustrated in FIG. 2E corresponds to FIG. 1D, and the tilt correction plate CP is further shifted closer to the optical axis than in FIG. 2D.

When the image projection apparatus 100 and the screen are installed at desired positions, a tilt angle of the screen normal line with respect to the optical axis is determined. This makes it possible to adjust the position of the tilt correction plate CP while monitoring field curvature and defocus on the screen.

### Example 1

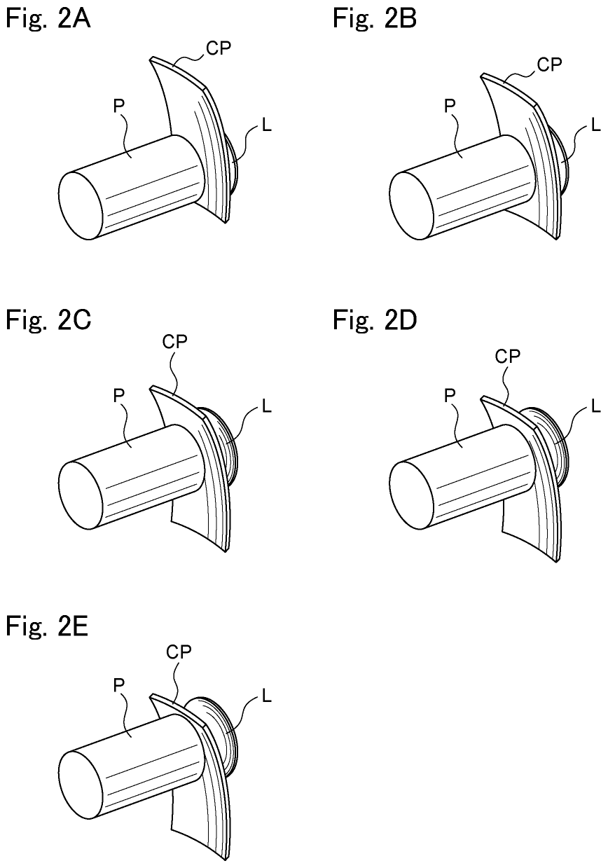

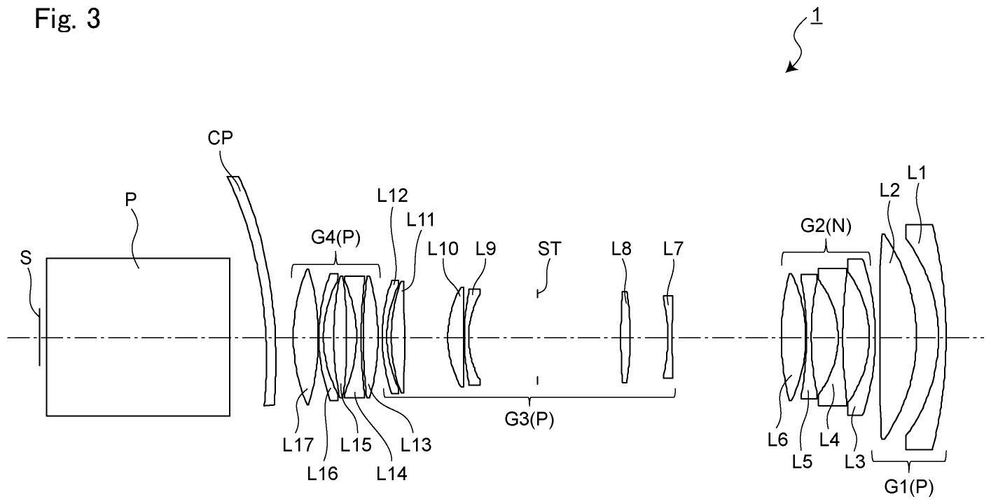

FIG. 3 is a layout diagram illustrating an optical system 1 according to Example 1. The optical system 1 includes an optical element P, a tilt correction plate CP, and lens elements L17, L16, . . . , L2, and L1 in order from a reduction conjugate point (for example, original image S) on the reduction side to a magnification conjugate point (for example, the screens SR1 and SR2) on the magnification side. An aperture stop ST that defines a region in which a light flux passes through the optical system 1 is located between the lens element L9 and the lens element L8. Regarding a surface number, a numerical example to be described later will be referred to. The plurality of lens elements L1 to L17 and the aperture stop ST constitute an imaging optical system. In addition, the tilt correction plate CP is positioned on the reduction side with respect to the aperture stop ST.

The optical element P can be made of a total internal reflection (TIR) prism, a prism for color separation and color synthesis, an optical filter, a parallel plate glass, a crystal low-pass filter, an infrared cut filter, and the like. A reduction conjugate point is set at a predetermined interval from the end face on the reduction side of the optical element P, and the original image S is located thereon.

The optical element P has two parallel and flat transmission surfaces (surfaces 1 and 2). The tilt correction plate CP has a first surface (surface 4) having a free-form surface shape on the reduction side and a second surface (surface 5) having a free-form surface shape on the magnification side. The lens element L17 has a biconvex shape (surfaces 8 and 9). The lens element L16 has a negative meniscus shape with the convex surfaces facing the reduction side (surfaces 10 and 11). The lens element L15 has a biconvex shape (surfaces 12 and 13). The lens element L14 has a biconcave shape (surfaces 14 and 15). The lens element L13 has a biconvex shape (surfaces 16 and 17). The lens element L12 has a negative meniscus shape with the convex surfaces facing the reduction side (surfaces 18 and 19). The lens element L11 has a biconvex shape (surfaces 20 and 21). The lens element L10 has a biconvex shape (surfaces 22 and 23). The lens element L9 has a negative meniscus shape with the convex surfaces facing the reduction side (surfaces 24 and 25).

The aperture stop ST is located on the magnification side from the lens element L9 (surface 26). The lens element L8 has a biconvex shape (surfaces 27 and 28). The lens element L7 has a biconcave shape (surfaces 29 and 30). The lens element L6 has a biconvex shape (surfaces 31 and 32). The lens element L5 has a biconcave shape (surfaces 33 and 34). The lens element L4 has a biconcave shape (surfaces 35 and 36). The lens element L3 has a negative meniscus shape with the convex surfaces facing the magnification side (surfaces 37 and 38). The lens element L2 has a biconvex shape (surfaces 39 and 40). The lens element L1 has a negative meniscus shape with the convex surfaces facing the magnification side (surfaces 41 and 42). The magnification conjugate point is located on the magnification side from the lens element L1 (surface 43).

Next, regarding the zooming function, the optical system 1 includes, in order from the reduction side to the magnification side, a fourth lens group G4, a third lens group G3, a second lens group G2, and a first lens group G1 that are movable independently of each other. As an example, the fourth lens group G4 has a positive power, and is constituted of the lens element L17 to the lens element L13. The third lens group G3 has a positive power, and is constituted of the lens element L12 to the lens element L7. The second lens group G2 has a negative power, and is constituted of the lens element L6 to the lens element L3. The first lens group G1 has a positive power, and is constituted of the lens element L2 to the lens element L1.

The optical system 1 may include a focus lens group that performs focus adjustment when an object distance is changed according to such a zooming operation, and a field curvature correction lens group that corrects field curvature aberration after the focus lens group performs focus adjustment. As an example, the first lens group G1 may function as a field curvature correction lens group, and the second lens group G2 may function as a focus lens group.

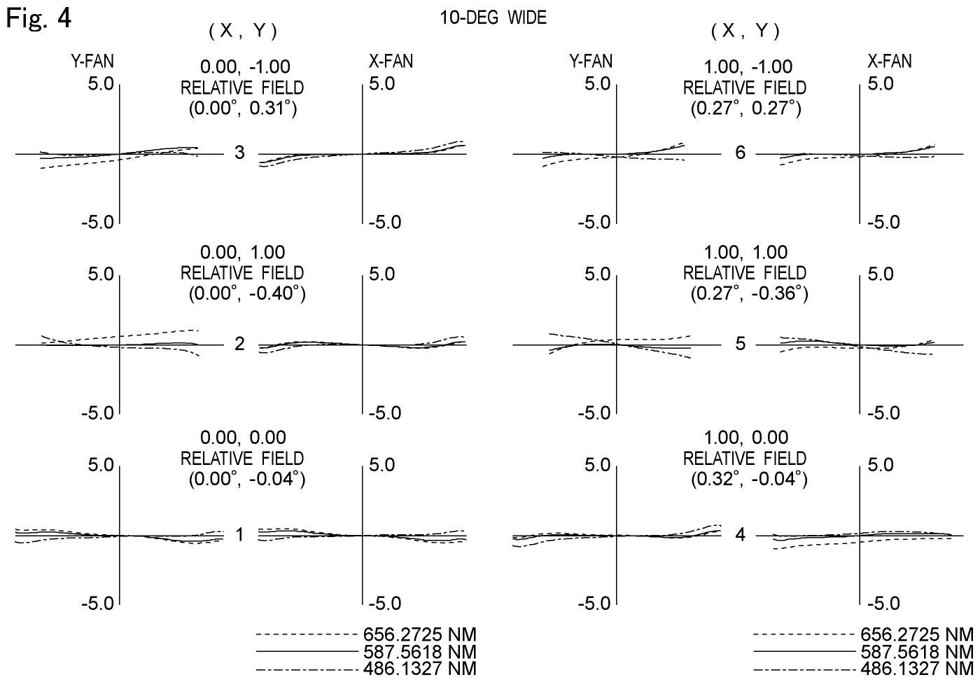

FIGS. 4 to 11 are diagrams illustrating lateral aberration on the wide side and the telephoto side at various shift angles (10 degrees, 20 degrees, 30 degrees, 40 degrees) in the optical system 1 according to Example 1. Each graph corresponds to normalized coordinates (X, Y)=(0, 0), (0, 1), (0, −1), (1, 0), (1, 1), and (1, −1) of a first rectangular region at the reduction conjugate point, respectively. The solid line indicates lateral aberration at a wavelength of 587.5618 nm, the dash line indicates lateral aberration at a wavelength of 656.2725 nm, and the dash-dot line indicates lateral aberration at a wavelength of 486.1327 nm.

From these graphs, it can be seen that excellent optical performance is exhibited even when the normal line of a second rectangular region (for example, the screen) is inclined at a tilt angle of 10 degrees to 40 degrees with respect to the optical axis of the optical system 1.

### Example 2

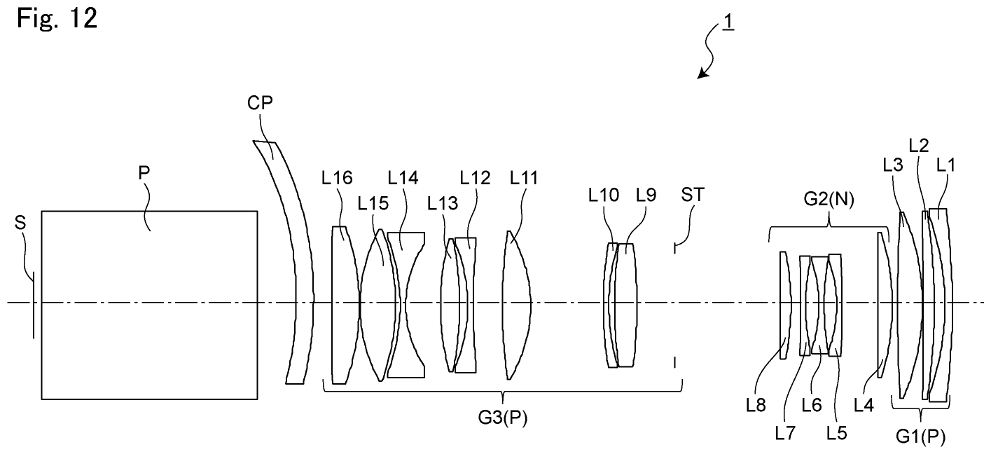

FIG. 12 is a layout diagram illustrating an optical system 1 according to Example 2. The optical system 1 includes an optical element P, a tilt correction plate CP, and lens elements L16, L15, . . . , L2, and L1 in order from a reduction conjugate point (for example, original image S) on the reduction side to a magnification conjugate point (for example, the screens SR1 and SR2) on the magnification side. An aperture stop ST that defines a region in which a light flux passes through the optical system 1 is located between the lens element L9 and the lens element L8. Regarding a surface number, a numerical example to be described later will be referred to. The plurality of lens elements L1 to L16 and the aperture stop ST constitute an imaging optical system. In addition, the tilt correction plate CP is positioned on the reduction side with respect to the aperture stop ST.

The optical element P can be made of a total internal reflection (TIR) prism, a prism for color separation and color synthesis, an optical filter, a parallel plate glass, a crystal low-pass filter, an infrared cut filter, and the like. A reduction conjugate point is set at a predetermined interval from the end face on the reduction side of the optical element P, and the original image S is located thereon.

The optical element P has two transmission surfaces that are parallel and flat (surfaces 1 and 2). The tilt correction plate CP has a first surface (surface 4) having a free-form surface shape on the reduction side and a second surface (surface 5) having a free-form surface shape on the magnification side. The lens element L16 has a biconvex shape (surfaces 8 and 9). The lens element L15 has a biconvex shape (surfaces 10 and 11). The lens element L14 has a biconcave shape (surfaces 12 and 13). The lens element L13 has a biconvex shape (surfaces 14 and 15). The lens element L12 has a biconcave shape (surfaces 16 and 17). The lens element L11 has a biconvex shape (surfaces 18 and 19). The lens element L10 has a negative meniscus shape with the convex surfaces facing the reduction side (surfaces 20 and 21). The lens element L9 has a biconvex shape (surfaces 22 and 23).

The aperture stop ST is located on the magnification side from the lens element L9 (surface 24). The lens element L8 has a positive meniscus shape with the convex surfaces facing the magnification side (surfaces 25 and 26). The lens element L7 has a biconcave shape (surfaces 27 and 28). The lens element L6 has a biconcave shape (surfaces 29 and 30). The lens element L5 has a negative meniscus shape with the convex surfaces facing the magnification side (surfaces 31 and 32). The lens element L4 has a positive meniscus shape with the convex surfaces facing the magnification side (surfaces 33 and 34). The lens element L3 has a biconvex shape (surfaces 35 and 36). The lens element L2 has a positive meniscus shape with the convex surfaces facing the magnification side (surfaces 37 and 38). The lens element L1 has a negative meniscus shape with the convex surfaces facing the magnification side (surfaces 39 and 40). The magnification conjugate point is located on the magnification side from the lens element L1 (surface 41).

Next, regarding the zooming function, the optical system 1 includes, in order from the reduction side to the magnification side, a third lens group G3, a second lens group G2, and a first lens group G1 that are movable independently of each other. As an example, the third lens group G3 has a positive power, and is constituted of the lens element L16 to the lens element L9. The second lens group G2 has a negative power, and is constituted of the lens element L8 to the lens element L4. The first lens group G1 has a positive power, and is constituted of the lens element L3 to the lens element L1.

The optical system 1 may include a focus lens group that performs focus adjustment when an object distance is changed according to such a zooming operation, and a field curvature correction lens group that corrects field curvature aberration after the focus lens group performs focus adjustment. As an example, the first lens group G1 may function as a field curvature correction lens group, and the second lens group G2 may function as a focus lens group.

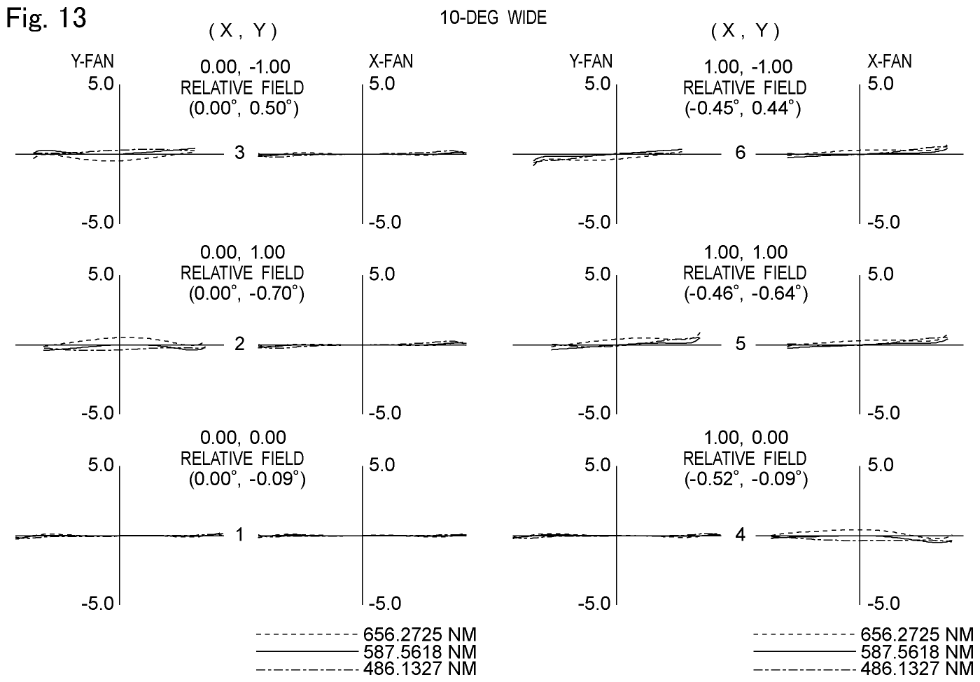

FIGS. 13 to 20 are diagrams illustrating lateral aberration on the wide side and the telephoto side at various shift angles (10 degrees, 20 degrees, 30 degrees, 40 degrees) in the optical system 1 according to Example 2. Normalized coordinates and wavelengths of each graph are similar to those in Example 1. From these graphs, it can be seen that excellent optical performance is exhibited even when the normal line of a second rectangular region (for example, the screen) is inclined at a tilt angle of 10 degrees to 40 degrees with respect to the optical axis of the optical system 1.

### Example 3

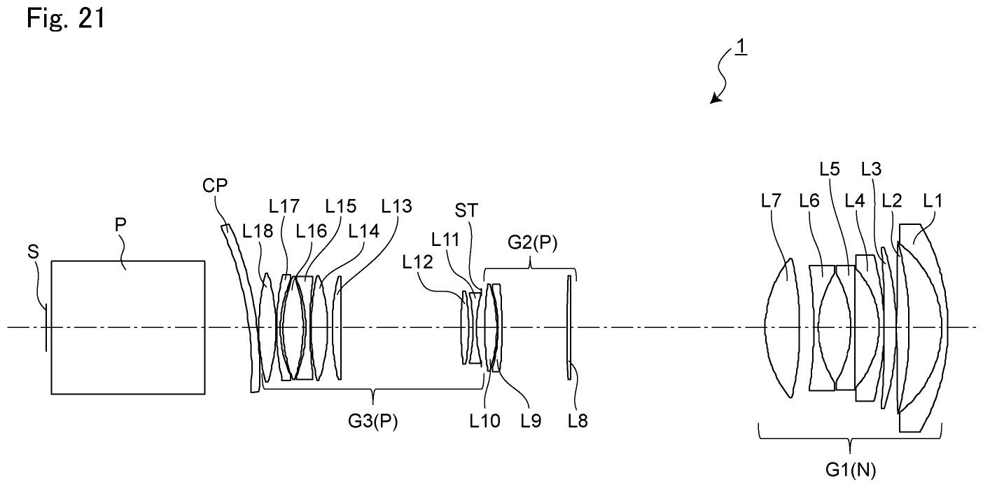

FIG. 21 is a layout diagram illustrating an optical system 1 according to Example 3. The optical system 1 includes an optical element P, a tilt correction plate CP, and lens elements L18, L17, . . . , L2, and L1 in order from a reduction conjugate point (for example, original image S) on the reduction side to a magnification conjugate point (for example, the screens SR1 and SR2) on the magnification side. An aperture stop ST that defines a region in which a light flux passes through the optical system 1 is located between the lens element L9 and the lens element L8. Regarding a surface number, a numerical example to be described later will be referred to. The plurality of lens elements L1 to L18 and the aperture stop ST constitute an imaging optical system. In addition, the tilt correction plate CP is positioned on the reduction side with respect to the aperture stop ST.

The optical element P can be made of a total internal reflection (TIR) prism, a prism for color separation and color synthesis, an optical filter, a parallel plate glass, a crystal low-pass filter, an infrared cut filter, and the like. A reduction conjugate point is set at a predetermined interval from the end face on the reduction side of the optical element P, and the original image S is located thereon.

The optical element P has two transmission surfaces that are parallel and flat (surfaces 1 and 2). The tilt correction plate CP has a first surface (surface 4) having a free-form surface shape on the reduction side and a second surface (surface 5) having a free-form surface shape on the magnification side. The lens element L18 has a biconvex shape (surfaces 8 and 9). The lens element L17 has a negative meniscus shape with the convex surfaces facing the reduction side (surfaces 10 and 11). The lens element L16 has a biconvex shape (surfaces 12 and 13). The lens element L15 has a biconcave shape (surfaces 14 and 15). The lens element L14 has a biconvex shape (surfaces 16 and 17). The lens element L13 has a biconvex shape (surfaces 18 and 19). The lens element L12 has a biconvex shape (surfaces 20 and 21). The lens element L11 has a biconcave shape (surfaces 22 and 23).

The aperture stop ST is located on the magnification side from the lens element L11 (surface 24). The lens element L10 has a biconvex shape (surfaces 25 and 26). The lens element L9 has a negative meniscus shape with the convex surfaces facing the magnification side (surfaces 27 and 28). The lens element L8 has a plano-convex shape with the convex surface facing the reduction side (surfaces 29 and 30). The lens element L7 has a biconvex shape (surfaces 31 and 32). The lens element L6 has a biconcave shape (surfaces 33 and 34). The lens element L5 has a negative meniscus shape with the convex surfaces facing the magnification side (surfaces 35 and 36). The lens element L4 has a negative meniscus shape with the convex surfaces facing the magnification side (surfaces 37 and 38). The lens element L3 has a positive meniscus shape with the convex surfaces facing the magnification side (surfaces 39 and 40). The lens element L2 has a biconvex shape (surfaces 41 and 42). The lens element L1 has a negative meniscus shape with the convex surfaces facing the magnification side (surfaces 43 and 44). The magnification conjugate point is located on the magnification side from the lens element L1 (surface 46).

Next, regarding the zooming function, the optical system 1 includes, in order from the reduction side to the magnification side, a third lens group G3, a second lens group G2, and a first lens group G1 that are movable independently of each other. As an example, the third lens group G3 has a positive power, and is constituted of the lens element L18 to the lens element L11. The second lens group G2 has a positive power, and is constituted of the lens element L10 to the lens element L8. The first lens group G1 has a negative power, and is constituted of the lens element L7 to the lens element L1.

The optical system 1 may include a focus lens group that performs focus adjustment when an object distance is changed according to such a zooming operation, and a field curvature correction group lens that corrects field curvature aberration after the focus lens group performs focus adjustment. As an example, the first lens group G1 may function as a field curvature correction lens group, and the second lens group G2 may function as a focus lens group.

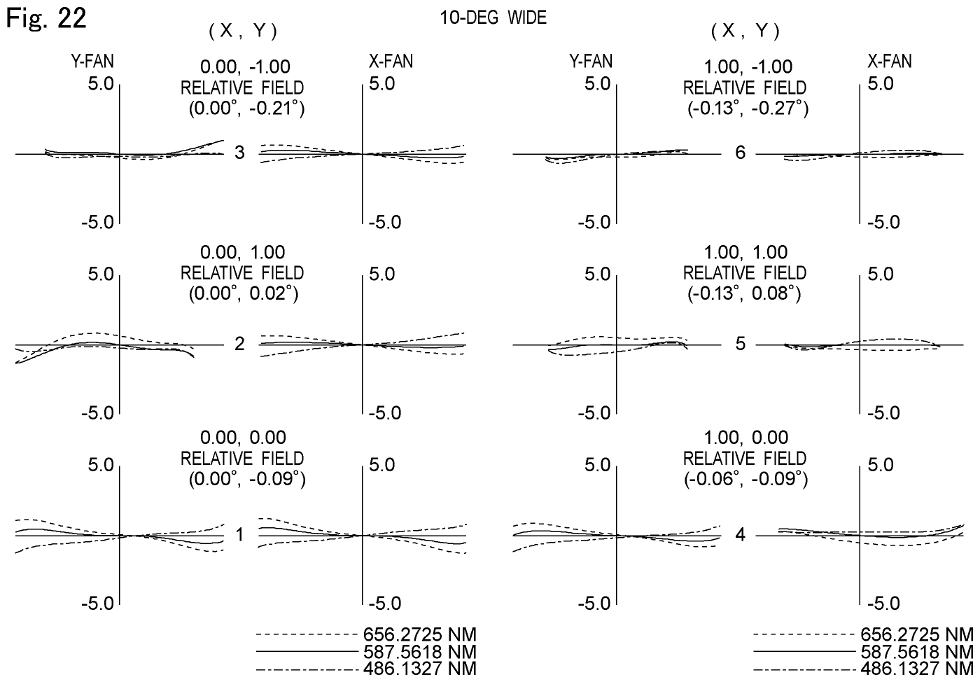

FIGS. 22 to 29 are diagrams illustrating lateral aberration on the wide side and the telephoto side at various shift angles (10 degrees, 20 degrees, 30 degrees, 40 degrees) in the optical system 1 according to Example 3. Normalized coordinates and wavelengths of each graph are similar to those in Example 1. From these graphs, it can be seen that excellent optical performance is exhibited even when the normal line of a second rectangular region (for example, the screen) is inclined at a tilt angle of 10 degrees to 40 degrees with respect to the optical axis of the optical system 1.

### Example 4

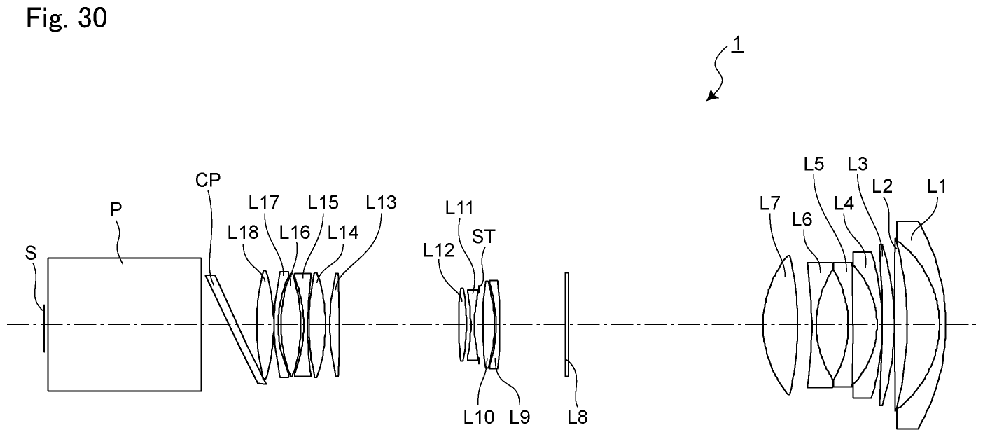

FIG. 30 is a layout diagram illustrating an optical system 1 according to Example 4. The optical system 1 includes an optical element P, a tilt correction plate CP, and lens elements L18, L17, . . . , L2, and L1 in order from a reduction conjugate point (for example, original image S) on the reduction side to a magnification conjugate point (for example, the screens SR1 and SR2) on the magnification side. An aperture stop ST that defines a region in which a light flux passes through the optical system 1 is located between the lens element L9 and the lens element L8. Regarding a surface number, a numerical example to be described later will be referred to. The plurality of lens elements L1 to L18 and the aperture stop ST constitute an imaging optical system. In addition, the tilt correction plate CP is positioned on the reduction side with respect to the aperture stop ST.

The optical element P can be made of a total internal reflection (TIR) prism, a prism for color separation and color synthesis, an optical filter, a parallel plate glass, a crystal low-pass filter, an infrared cut filter, and the like. A reduction conjugate point is set at a predetermined interval from the end face on the reduction side of the optical element P, and the original image S is located thereon.

The optical element P has two transmission surfaces that are parallel and flat (surfaces 1 and 2). The tilt correction plate CP has a first surface (surface 4) having a free-form surface shape on the reduction side and a second surface (surface 5) having a free-form surface shape on the magnification side. The lens element L18 has a biconvex shape (surfaces 8 and 9). The lens element L17 has a negative meniscus shape with the convex surfaces facing the reduction side (surfaces 10 and 11). The lens element L16 has a biconvex shape (surfaces 12 and 13). The lens element L15 has a biconcave shape (surfaces 14 and 15). The lens element L14 has a biconvex shape (surfaces 16 and 17). The lens element L13 has a biconvex shape (surfaces 18 and 19). The lens element L12 has a biconvex shape (surfaces 20 and 21). The lens element L11 has a biconcave shape (surfaces 22 and 23).

The aperture stop ST is located on the magnification side from the lens element L11 (surface 24). The lens element L10 has a biconvex shape (surfaces 25 and 26). The lens element L9 has a negative meniscus shape with a convex surface facing the magnification side (surfaces 27 and 28). The lens element L8 has a plano-convex shape with a convex surface facing the reduction side (surfaces 29 and 30). The lens element L7 has a biconvex shape (surfaces 31 and 32). The lens element L6 has a biconcave shape (surfaces 33 and 34). The lens element L5 has a negative meniscus shape with the convex surfaces facing the magnification side (surfaces 35 and 36). The lens element L4 has a negative meniscus shape with the convex surfaces facing the magnification side (surfaces 37 and 38). The lens element L3 has a positive meniscus shape with the convex surfaces facing the magnification side (surfaces 39 and 40). The lens element L2 has a biconvex shape (surfaces 41 and 42). The lens element L1 has a negative meniscus shape with the convex surfaces facing the magnification side (surfaces 43 and 44). The magnification conjugate point is located on the magnification side from the lens element L1 (surface 46).

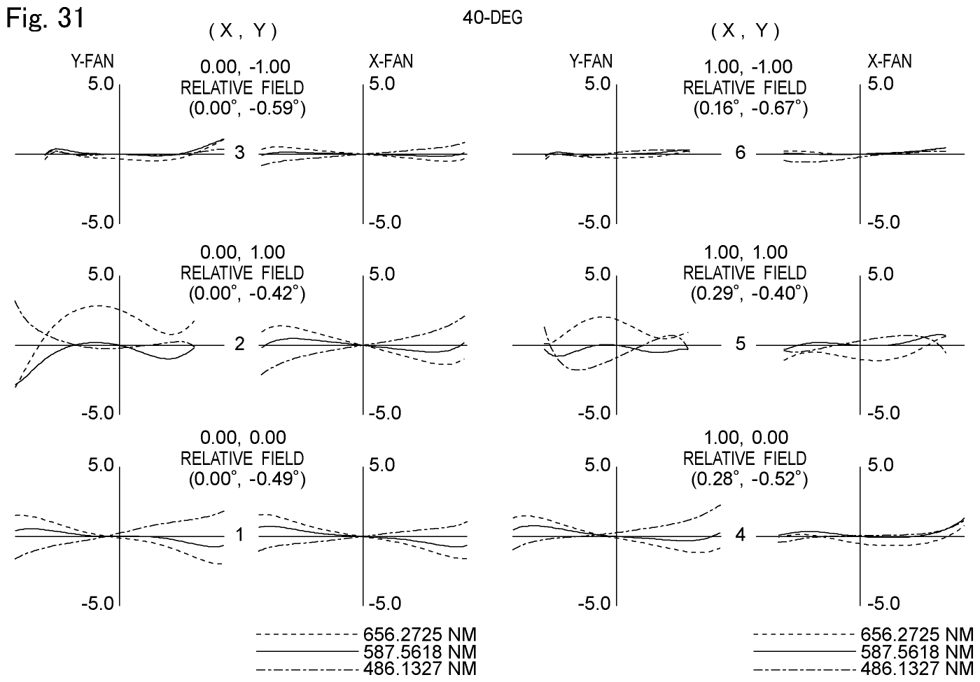

The optical system 1 according to Example 4 does not have a zooming function. FIG. 31 is a diagram illustrating lateral aberration at a specific shift angle (40 degrees) in the optical system 1 according to Example 4. Normalized coordinates and wavelengths of each graph are similar to those in Example 1. From these graphs, it can be seen that excellent optical performance is exhibited even when the normal line of the second rectangular region (for example, the screen) is inclined at a tilt angle of 40 degrees with respect to the optical axis of the optical system 1.

Next, conditions that can be satisfied by the optical system according to the present embodiment will be described below. Note that although a plurality of conditions are defined for the optical system according to each of the embodiments, all of these plurality of conditions may be satisfied, or the individual conditions may be satisfied to obtain the corresponding effects.

The optical system according to the present embodiment is an optical system having a reduction conjugate point on a reduction side and a magnification conjugate point on a magnification side that are optically conjugate with each other. The optical system includes an imaging optical system having a plurality of lens elements that are rotationally symmetric with respect to an optical axis, and an aperture stop. A first rectangular region at the reduction conjugate point and a second rectangular region at the magnification conjugate point have an optically conjugate image forming relation. A normal line of the second rectangular region is inclined at a tilt angle of 10 degrees or more with respect to the optical axis. A tilt correction plate CP that corrects defocus in the first rectangular region or the second rectangular region is positioned on the reduction side of the aperture stop between the reduction conjugate point and the magnification conjugate point. The tilt correction plate CP has a first surface having a free-form surface shape on the reduction side and a second surface having a free-form surface shape on the magnification side. The tilt correction plate CP is configured to satisfy the following expression (10), where two end points of the first rectangular region in a meridional plane including the normal line and the optical axis are defined as points A and B:

$$pb - pa > 0 \qquad ( 10 )$$

$$pa = ( nd - 1 ) \times ( 1 / ra 1 - 1 / ra 2 ) \qquad ( 10 A )$$

$$pb = ( nd - 1 ) \times ( 1 / rb 1 - 1 / rb 2 ) . \qquad ( 10 B )$$

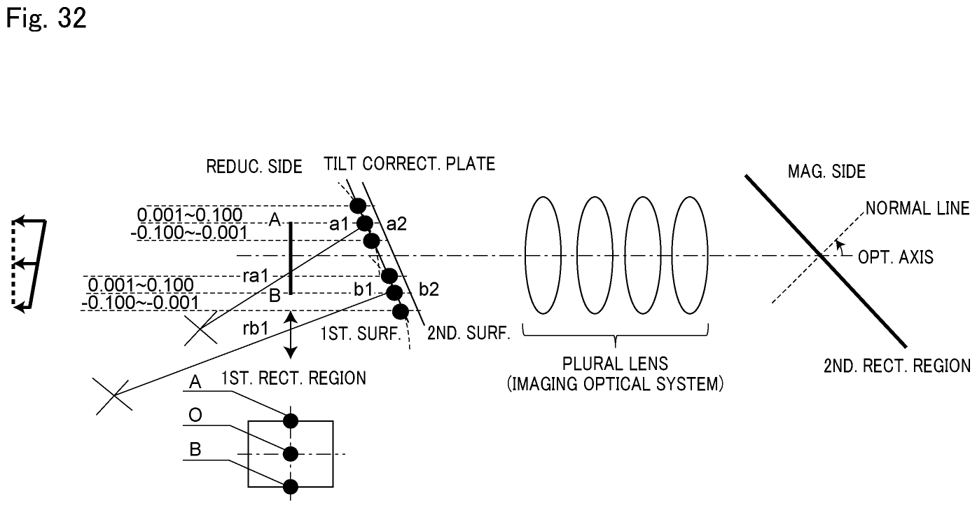

FIG. 32 is an explanatory diagram illustrating partial radii of curvature on the first surface and the second surface of the tilt correction plate. The sheet surface of FIG. 32 corresponds to a meridional plane including the normal line of the second rectangular region and the optical axis of the imaging optical system. For convenience two end points of the first rectangular region are defined as a point A on the upper side, a point B on the lower side, and a point O is defined on the center of the first rectangular region. Actually, the same applies to a case where the vertical direction is reversed.

The variable ra1 can be defined as a partial radius of curvature in the meridional plane at a point a1 where a straight line parallel to the optical axis passes through the point A and intersects with the first plane of the tilt correction plate CP. The variable ra2 can be defined as a partial radius of curvature in the meridional plane at a point a2 where a straight line parallel to the optical axis passes through the point A and intersects with the second plane of the tilt correction plate CP. The variable rb1 can be defined as a partial radius of curvature in the meridional plane at a point b1 where a straight line parallel to the optical axis passes through the point B and intersects with the first plane of the tilt correction plate CP. The variable rb2 can be defined as a partial radius of curvature in the meridional plane at a point b2 where a straight line parallel to the optical axis passes through the point B and intersects with the second surface of the tilt correction plate CP. The variable nd is a refractive index of the tilt correction plate CP. Using these variables, a partial optical power pa related to the points a1 and a2 and a partial optical power pb related to the points b1 and b2 can be defined as expressions (10A) and (10B).

In case of the optical system according to the present embodiment satisfies the expression (10), the partial optical power pb becomes larger than the partial optical power pa. This makes it possible to correct defocus and field curvature in the first rectangular region or the second rectangular region, the defocus and the field curvature being caused by the inclination of the second rectangular region.

Here, the partial curvature radius at an arbitrary point on the free-form surface (the first surface and the second surface) of the tilt correction plate CP can be mathematically calculated using the first derivative and the second derivative of the function representing the free-form surface. When the function representing the free-form surface is unknown, the partial radius of curvature can be defined by the radius of a circle passing through three points on the free-form surface: a middle point on the free-form surface, an upper point on the free-form surface separated from the middle point by the distance of +0.001 mm to +0.100 mm in a direction perpendicular to the optical axis, and a lower point on the free-form surface separated from the middle point by the distance of −0.001 mm to −0.100 mm in a direction perpendicular to the optical axis.

The optical system according to the present embodiment is an optical system having a reduction conjugate point on a reduction side and a magnification conjugate point on a magnification side that are optically conjugate with each having a plurality of lens elements that are rotationally symmetric with respect to an optical axis, and an aperture stop.

A first rectangular region at the reduction conjugate point and a second rectangular region at the magnification conjugate point have an optically conjugate image forming relation. A normal line of the second rectangular region is inclined at a tilt angle of 10 degrees or more with respect to the optical axis. A tilt correction plate CP that corrects defocus in the first rectangular region or the second rectangular region is positioned on the reduction side of the aperture stop between the reduction conjugate point and the magnification conjugate point. The tilt correction plate CP has a first surface having a free-form surface shape on the reduction side and a second surface having a free-form surface shape on the magnification side. The tilt correction plate CP is configured to satisfy the following expressions (11A) and (11B), where two end points of the first rectangular region in a meridional plane including the normal line and the optical axis are defined as points A and B:

$$α 1 A - α 1 B > 0 \qquad ( 11 A )$$

$$α 2 A - α 2 B > 0 \qquad ( 11 B )$$

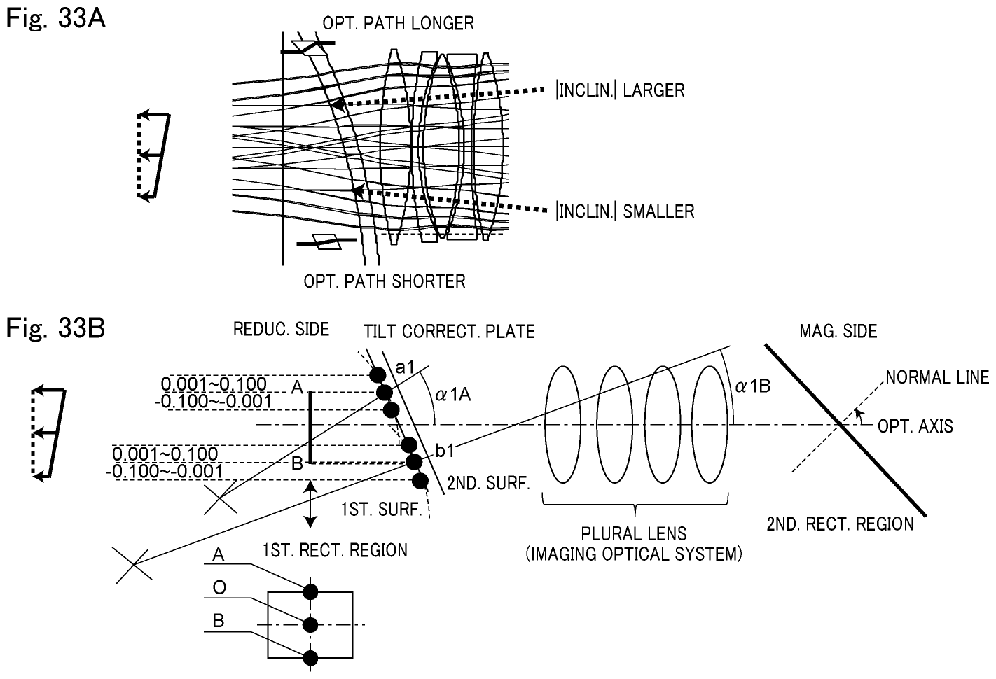

FIG. 33A is an explanatory diagram illustrating paths of various light rays passing through the tilt correction plate. FIG. 33B is an explanatory diagram illustrating partial radii of curvature on the first surface and the second surface of the tilt correction plate. The sheet surface of FIG. 33B corresponds to a meridional plane including the normal line of the second rectangular region and the optical axis of the imaging optical system. For convenience two end points of the first rectangular region are defined as a point A on the upper side, a point B on the lower side, and a point O is defined on the center of the first rectangular region. Actually, the same applies to a case where the vertical direction is reversed.

The variable α1A can be defined as an angle at which a straight line connecting a point a1 (where a straight line parallel to the optical axis passes through the point A and intersects with the first surface of the tilt correction plate CP) and the center of the partial radius of curvature at the point a1 intersects with the optical axis. The variable α1B can be defined as an angle at which a straight line connecting a point b1 (where a straight line parallel to the optical axis passes through the point B and intersects with the first surface of the tilt correction plate CP) and the center of the partial radius of curvature at the point b1 intersects with the optical axis. The variable α2A can be defined as an angle at which a straight line connecting a point a2 (where a straight line parallel to the optical axis passes through the point A and intersects with the second surface of the tilt correction plate CP) and the center of the partial radius of curvature at the point a2 intersects with the optical axis. The variable α2B can be defined as an angle at which a straight line connecting a point b2 (where a straight line parallel to the optical axis passes through the point B and intersects with the second surface of the tilt correction plate CP) and the center of the partial radius of curvature at the point b2 intersects with the optical axis. The variable nd is a refractive index of the tilt correction plate CP.

In case of the optical system according to the present embodiment satisfies the expressions (11A) and (11B), the inclination of the light ray passing through the points a1 and a2 becomes larger than the inclination of the light ray passing through the points b1 and b2. This makes it possible to correct defocus and field curvature in the first rectangular region or the second rectangular region, the defocus and the field curvature being caused by the inclination of the second rectangular region.

The optical system according to the present embodiment is an optical system having a reduction conjugate point on a reduction side and a magnification conjugate point on a magnification side that are optically conjugate with each having a plurality of lens elements that are rotationally symmetric with respect to an optical axis, and an aperture stop. A first rectangular region at the reduction conjugate point and a second rectangular region at the magnification conjugate point have an optically conjugate image forming relation. A normal line of the second rectangular region is inclined at a tilt angle of 10 degrees or more with respect to the optical axis. A tilt correction plate CP that corrects defocus in the first rectangular region or the second rectangular region is positioned on the reduction side of the aperture stop between the reduction conjugate point and the magnification conjugate point. The tilt correction plate CP has a first surface having a free-form surface shape on the reduction side and a second surface having a free-form surface shape on the magnification side. The tilt correction plate CP is configured to satisfy the following expressions (20), (21), and (22), where a surface including the normal line and the optical axis is defined as a meridional plane, and a point at which the optical axis intersects with the first rectangular region is defined as a point O:

$$py - px > 0 \qquad ( 20 )$$

$$px = ( nd - 1 ) \times ( 1 / rxo 1 - 1 / rxo 2 ) \qquad ( 20 A )$$

$$py = ( nd - 1 ) \times ( 1 / ryo 1 - 1 / ryo 2 ) \qquad ( 20 B )$$

$$α o 1 < 0 \qquad ( 21 )$$

$$α o 1 - α o 2 > 0. \qquad ( 22 )$$

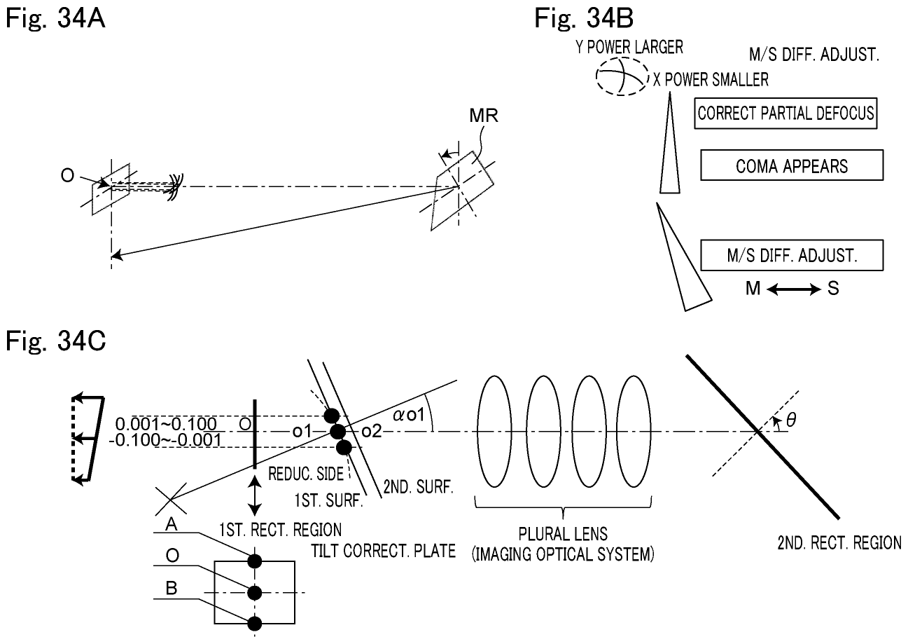

FIG. 34A is an explanatory diagram illustrating a situation in which the optical axis is inclined by the folding mirror MR. FIG. 34B is an explanatory diagram illustrating how defocus (partial defocus) and coma aberration in the second rectangular region (for example, the screen) caused by the inclination of the optical axis can be reduced using a relation between the Y-direction optical power of the meridional plane and the X-direction optical power of the sagittal plane. FIG. 34C is an explanatory diagram illustrating partial radii of curvature on the first surface and the second surface of the tilt correction plate. The sheet surface of FIG. 34C corresponds to a meridional plane including the normal line of the second rectangular region and the optical axis of the imaging optical system. For convenience two end points of the first rectangular region are defined as a point A on the upper side, a point B on the lower side, and a point O on the center of the first rectangular region. Actually, the same applies to a case where the vertical direction is reversed.

The variable rxo1 can be defined as a partial radius of curvature in a plane perpendicular to the meridional plane at a point o1 where the optical axis passes through the point O and intersects with the first plane of the tilt correction plate CP. The variable rxo2 can be defined as a partial radius of curvature in a plane perpendicular to the meridional plane at a point o2 where the optical axis passes through the point O and intersects with the second plane of the tilt correction plate CP. The variable ryo1 can be defined as a partial radius of curvature in the meridional plane at a point o1 where the optical axis passes through the point O and intersects with the first plane of the tilt correction plate CP. The variable ryo2 can be defined as a partial radius of curvature in the meridional plane at a point O2 where the optical axis passes through the point O and intersects with the second plane of the tilt correction plate CP. The variable col can be defined as an angle at which a straight line connecting a point o1 (at which the optical axis passes through the point O and intersects with the first surface of the tilt correction plate CP) and the center of the partial radius of curvature at the point o1 intersects with the optical axis. The variable αo2 can be defined as an angle at which a straight line connecting a point o2 (at which the optical axis passes through the point O and intersects with the second surface of the tilt correction plate CP) and the center of the partial radius of curvature at the point o2 intersects with the optical axis. The variable nd is a refractive index of the tilt correction plate CP. Using these variables, the X-direction optical power px of the sagittal plane and the Y-direction optical power py of the meridional plane regarding the points o1 and o2 can be defined as in expressions (20A) and (20B).

In case of the optical system according to the present embodiment satisfies the expression (20), the Y-direction optical power py becomes larger than the X-direction optical power px. Further, in case of the optical system satisfies the expressions (21) and (22), the inclination of the light ray passing through the point o1 becomes larger than the inclination of the light ray passing through the point O2. This makes it possible to correct defocus, field curvature, and astigmatism in the first rectangular region or the second rectangular region, the defocus, the field curvature and the astigmatism being caused by the inclination of the second rectangular region.

The configurations described in FIGS. 32 to 34 and the functions and effects thereof may be adopted individually, or may be adopted in a combination of all or a part thereof.

In the optical system according to the present embodiment, the tilt correction plate may be configured to satisfy the following expression (31):

$$- 0.00 \; 05 < py < 0. . \qquad ( 31 )$$

In case of satisfying the expression (31), an appropriate tilt correction plate can be obtained. If py exceeds the upper limit, a sufficient space for arranging the tilt correction plate cannot be secured. If py falls below the lower chromatic aberration is increased.

In the optical system according to the present embodiment, the tilt correction plate may be configured to satisfy the following expression (32):

$$- 0.001 < px < 0. . \qquad ( 32 )$$

In case of satisfying the expression (32), an appropriate tilt correction plate can be obtained. If px exceeds the upper limit, a sufficient space for arranging the tilt correction plate cannot be secured. If px falls below the lower chromatic aberration is increased.

In the optical system according to the present embodiment, the tilt correction plate may be configured to satisfy the following expression (33):

$$pb - pa < 0.0005 . \qquad ( 33 )$$

In case of satisfying the expression (33), an appropriate tilt correction plate can be obtained. If pb-pa exceeds the upper limit, the chromatic aberration of magnification is increased.

In the optical system according to the present embodiment, the tilt correction plate may be configured to satisfy the following expression (34):

$$py - px < 0.001 . \qquad ( 34 )$$

In case of satisfying the expression (34), an appropriate tilt correction plate can be obtained. If py-px exceeds the upper limit, astigmatism is increased.

In the optical system according to the present embodiment, the tilt correction plate may be configured to satisfy the following expression (35):

$$α o 1 - αo2 < 1.5 . \qquad ( 35 )$$

In case of satisfying the expression (35), an appropriate tilt correction plate can be obtained. If αo1-αo2 exceeds the upper limit, coma aberration is increased.

In the optical system according to the present embodiment, the tilt correction plate may be configured to satisfy the following expression (36):

$$α 1 A - α 1 B < 20. \qquad ( 36 )$$

In case of satisfying the expression (36), an appropriate tilt correction plate can be obtained. If α1A-α1B exceeds the upper limit, the chromatic aberration of magnification is increased.

In the optical system according to the present embodiment, the tilt correction plate may be configured to satisfy the following expression (37):

$$α 2 A - α 2 B < 15. \qquad ( 37 )$$

In case of satisfying the expression (37), an appropriate tilt correction plate can be obtained. If α2A-α2B exceeds the upper limit, the chromatic aberration of magnification is increased.

In the optical system according to the present embodiment, the tilt correction plate may be positioned between the reduction conjugate point and the imaging optical system.

According to such a configuration, the tilt correction plate can be inserted while utilizing the existing design of the imaging optical system as it is.

In the optical system according to the present embodiment, the tilt correction plate can be displaced in a direction intersecting with the optical axis when the tilt angle is changed.

According to such a configuration, a single tilt correction plate can be used according to a plurality of tilt angles, so that it is not necessary to prepare a plurality of tilt correction plates corresponding to the plurality of tilt angles.

Hereinafter, numerical examples of the optical system according to Examples 1 to 4 are described. In each of the numerical examples, in the table, the unit of length is all “mm”, and the unit of angle of view is all “o” (degree). Further, in each of the numerical examples, a radius of curvature (ROC), a surface interval, a refractive index (R. I.) for d line, and an Abbe number (NO.) for d line are shown. Further, the various quantities in each of the numerical examples are calculated based on a wavelength of 550 nm. Furthermore, the expression “ZOOM INTERVAL” in the surface interval means that it can be changed according to the zooming operation, as shown in the attached table.

A free-form surface (FFS) shape of the tilt correction plate is defined by the following formulas using a local orthogonal coordinate system (x, y, z) with the surface vertex thereof as origin point.

$$z = \frac{{cr}^{2}}{1 + \sqrt{1 - ( 1 + k ) {c}^{2} {r}^{2}}} + {\sum }_{j = 2}^{137} {C}_{j} {x}^{m} {y}^{n} \qquad [ Mathematical Formula 1 ]$$

$$j = \frac{{( m + n )}^{2} + m + 3 n}{2} + 1 \qquad [ Mathematical Formula 2 ]$$

where, Z is a sag height of a surface as measured in parallel to z-axis, r is a distance in the radial direction (=√(x²+y²)), c is a vertex curvature, k is a conic constant, and Cⱼ is a coefficient of a monomial X^{m}yⁿ.

### Numerical Example 1

Regarding the optical system of Numerical Example 1 (corresponding to Example 1), Table 1 shows lens data, Table 2 shows Y eccentricity amounts and a rotation amounts of the tilt correction plate. Table 3 shows lens intervals during zooming operation. Table 4 shows free-form surface shape data of the tilt correction plate.

The term “D.A.R. (decenter and return)” in Table 2 means coordinate transformation between global coordinates and local coordinates during numerical calculation. The lateral aberration diagrams shown in FIGS. 2 to 20 correspond to image height coordinates (x, y)=(0.000, 0.000), (0.000, 12.960), (0.000, −12.960), (10.368, 0.000), (10.368, 12.960), (10.368, −12.960) of the first rectangular region, respectively. The same applies to other numerical examples.

TABLE 1

| | | | | SURFACE | | ABBE |
|---|---|---|---|---|---|---|
| | | | ROC | INTERVAL | R.I. | NO. |
| REDUC. SIDE | | | | 3.000 | | |
| CONJUGATE POINT | | | | | | |
| | P | 1 | | 85.000 | 1.51680 | 64.20 |
| | | 2 | | ZOOM | | |
| | | | | INTERVAL | | |
| | | 3 | | 0.000 | | |
| FREE-FORM | CP | 4 | ∞ | 5.000 | 1.51680 | 64.17 |
| FREE-FORM | | 5 | ∞ | 0.000 | | |
| | | 6 | | 0.000 | | |
| | | 7 | | 12.579 | | |
| G4(P) | L17 | 8 | 82.818 | 11.573 | 1.45860 | 90.19 |
| | | 9 | −113.311 | 0.200 | | |
| | L16 | 10 | 83.242 | 2.200 | 1.57501 | 41.50 |
| | | 11 | 56.566 | 4.641 | | |
| | L15 | 12 | 137.339 | 6.149 | 1.45860 | 90.19 |
| | | 13 | −215.624 | 4.489 | | |
| | L14 | 14 | −64.993 | 2.200 | 1.56732 | 42.82 |
| | | 15 | 245.672 | 1.008 | | |
| | L13 | 16 | 244.929 | 6.695 | 1.45860 | 90.19 |
| | | 17 | −108.820 | ZOOM | | |
| | | | | INTERVAL | | |
| G3(P) | L12 | 18 | 79.708 | 2.200 | 1.62041 | 60.34 |
| | | 19 | 55.555 | 2.001 | | |
| | L11 | 20 | 74.458 | 6.144 | 1.45860 | 90.19 |
| | | 21 | −1268.660 | 20.208 | | |
| | L10 | 22 | 47.865 | 7.423 | 1.45860 | 90.19 |
| | | 23 | −1412.711 | 0.200 | | |
| | L9 | 24 | 110.804 | 2.000 | 1.51680 | 64.20 |
| | | 25 | 40.622 | 31.854 | | |
| | ST | 26 | | 38.847 | | |
| | L8 | 27 | 282.625 | 4.348 | 1.73800 | 32.33 |
| | | 28 | −138.493 | 17.514 | | |
| | L7 | 29 | −74.341 | 2.000 | 1.51680 | 64.20 |
| | | 30 | 415.087 | ZOOM | | |
| | | | | INTERVAL | | |
| G2(N) | L6 | 31 | 124.396 | 11.376 | 1.53172 | 48.84 |
| | | 32 | −68.559 | 0.200 | | |
| | L5 | 33 | −158.530 | 2.200 | 1.49700 | 81.61 |
| | | 34 | 129.073 | 12.512 | | |
| | L4 | 35 | −43.724 | 2.200 | 1.49700 | 81.61 |
| | | 36 | 241.157 | 12.340 | | |
| | L3 | 37 | −51.283 | 2.800 | 1.62041 | 60.34 |
| | | 38 | −113.926 | ZOOM | | |
| | | | | INTERVAL | | |
| G1(P) | L2 | 39 | 1296.534 | 17.013 | 1.80420 | 46.50 |
| | | 40 | −83.432 | 10.236 | | |
| | L1 | 41 | −77.676 | 3.500 | 1.80518 | 25.46 |
| | | 42 | −21.664 | 0.000 | | |
| | | 43 | | 6000.000 | | |

| | |
|---|---|
| MAG. SIDE | 0.000 |
| CONJUGATE POINT | |

TABLE 2
Y ECC. DATA

| | | | Y ECCENTRICITY AMOUNT [mm] | | | |
|---|---|---|---|---|---|---|
| SURF. | ECC. | WIDE | WIDE | WIDE | WIDE | WIDE |
| NO. | TYPE | 0 deg. | 10 deg. | 20 deg. | 30 deg. | 40 deg. |
| 3 | NORMAL | 6.507 | 3.698 | −20.691 | −27.449 | −32.363 |
| 4 | D.A.R. | −60.040 | −60.040 | −60.040 | −60.040 | −60.040 |
| 5 | D.A.R. | −59.670 | −59.670 | −59.670 | −59.670 | −59.670 |
| 6 | NORMAL | −6.507 | −3.698 | 20.691 | 27.449 | 32.363 |
| SURF. | ECC. | TELE. | TELE. | TELE. | TELE. | TELE. |
| NO. | TYPE | 0 deg. | 10 deg. | 20 deg. | 30 deg. | 40 deg. |
| 3 | NORMAL | 5.462 | −8.748 | −24.349 | −32.094 | −36.776 |
| 4 | D.A.R. | −60.040 | −60.040 | −60.040 | −60.040 | −60.040 |
| 5 | D.A.R. | −59.670 | −59.670 | −59.670 | −59.670 | −59.670 |
| 6 | NORMAL | −5.462 | 8.748 | 24.349 | 32.094 | 36.776 |

α ROT.

| | | α ROTATION AMOUNT [degree] | | | | |
|---|---|---|---|---|---|---|
| SURF. | ECC. | WIDE | WIDE | WIDE | WIDE | WIDE |
| NO. | TYPE | 0 deg. | 10 deg. | 20 deg. | 30 deg. | 40 deg. |
| 4 | D.A.R. | −29.8 | −29.8 | −29.8 | −29.8 | −29.8 |
| 5 | D.A.R. | −29.8 | −29.8 | −29.8 | −29.8 | −29.8 |
| 43 | NORMAL | 0.0 | 10.0 | 20.0 | 30.0 | 40.0 |
| SURF. | ECC. | TELE. | TELE. | TELE. | TELE. | TELE. |
| NO. | TYPE | 0 deg. | 10 deg. | 20 deg. | 30 deg. | 40 deg. |
| 4 | D.A.R. | −29.8 | −29.8 | −29.8 | −29.8 | −29.8 |
| 5 | D.A.R. | −29.8 | −29.8 | −29.8 | −29.8 | −29.8 |
| 43 | NORMAL | 0.0 | 10.0 | 20.0 | 30.0 | 40.0 |

TABLE 3
INTERVAL DATA

| SURF. | WIDE | WIDE | WIDE | WIDE | WIDE |
|---|---|---|---|---|---|
| NO. | 0 deg. | 10 deg. | 20 deg. | 30 deg. | 40 deg. |
| 2 | 12.173 | 12.171 | 12.197 | 12.200 | 12.196 |
| 17 | 2.000 | 2.000 | 2.000 | 2.000 | 2.000 |
| 30 | 50.731 | 50.731 | 50.731 | 50.731 | 50.731 |
| 38 | 2.000 | 2.000 | 2.000 | 2.000 | 2.000 |
| SURF | TELE. | TELE. | TELE. | TELE. | TELE. |
| NO. | 0 deg. | 10 deg. | 20 deg. | 30 deg. | 40 deg. |
| 2 | 15.475 | 15.482 | 15.498 | 15.494 | 15.472 |
| 17 | 18.920 | 18.920 | 18.920 | 18.920 | 18.920 |
| 30 | 2.000 | 2.000 | 2.000 | 2.000 | 2.000 |
| 38 | 30.512 | 30.512 | 30.512 | 30.512 | 30.512 |

TABLE 4
FREE-FORM
COEFFICIENTS OF XY POLYNOMINAL

| | X\hat{ }0 | X\hat{ }2 | X\hat{ }4 | X\hat{ }6 | X\hat{ }8 | X\hat{ }10 |
|---|---|---|---|---|---|---|
| S4 | k = 0 | | | | | |
| Y\hat{ }0 | | −2.7858E−03 | −8.6540E−07 | 9.0652E−11 | 1.6808E−12 | −1.0392E−15 |
| Y\hat{ }1 | −2.3920E−01 | 1.2425E−06 | 2.6932E−08 | −4.2597E−11 | −1.6712E−14 | |
| Y\hat{ }2 | −6.5539E−03 | −5.6068E−07 | 7.9742E−10 | 9.8197E−13 | 1.2852E−16 | |
| Y\hat{ }3 | 7.4837E−05 | 1.1148E−08 | −3.9488E−11 | −8.5242E−15 | | |
| Y\hat{ }4 | −8.3293E−07 | 3.9630E−11 | 4.9858E−13 | 2.0871E−17 | | |
| Y\hat{ }5 | 2.4519E−09 | −2.6321E−12 | −1.8210E−15 | | | |
| Y\hat{ }6 | 3.2063E−11 | −7.1925E−15 | −2.6553E−18 | | | |
| Y\hat{ }7 | −2.9204E−13 | 5.0493E−16 | | | | |
| Y\hat{ }8 | −2.2614E−15 | −2.9279E−18 | | | | |
| Y\hat{ }9 | 4.5711E−17 | | | | | |
| Y\hat{ }10 | −2.1268E−19 | | | | | |
| S5 | k = 0 | | | | | |
| Y\hat{ }0 | | −2.4070E−03 | −1.0775E−06 | −1.4980E−10 | 1.2816E−12 | −7.6646E−16 |
| Y\hat{ }1 | −2.9772E−01 | −2.4388E−05 | 7.1741E−08 | −1.9118E−11 | −1.2064E−14 | |
| Y\hat{ }2 | −4.1230E−03 | 3.4016E−07 | −1.7944E−09 | 4.0243E−13 | 9.4718E−17 | |
| Y\hat{ }3 | 1.1277E−05 | 1.3511E−09 | 2.6516E−11 | −2.6590E−15 | | |
| Y\hat{ }4 | 6.7572E−08 | −5.2052E−11 | −3.3248E−13 | 4.3638E−19 | | |
| Y\hat{ }5 | −1.5862E−09 | −5.5361E−13 | 3.1610E−15 | | | |
| Y\hat{ }6 | −1.7700E−11 | 2.4882E−15 | −1.3540E−17 | | | |
| Y\hat{ }7 | 1.9041E−13 | 1.5482E−16 | | | | |
| Y\hat{ }8 | 1.8992E−15 | −1.2037E−18 | | | | |
| Y\hat{ }9 | −2.5604E−17 | | | | | |
| Y\hat{ }10 | 5.3218E−20 | | | | | |

### Numerical Example 2

Regarding the optical system of Numerical Example 2 (corresponding to Example 2), Table 5 shows lens data, Table 6 shows Y eccentricity amounts and a rotation amounts of the tilt correction plate. Table 7 shows lens intervals during zooming operation. Table 8 shows free-form surface shape data of the tilt correction plate.

TABLE 5

| | | | | SURFACE | | ABBE |
|---|---|---|---|---|---|---|
| | | | ROC | INTERVAL | R.I. | NO. |
| REDUC. SIDE | | | | 3.000 | | |
| CONJUGATE POINT | | | | | | |
| | P | 1 | | 85.000 | 1.51680 | 64.20 |
| | | 2 | | ZOOM | | |
| | | | | INTERVAL | | |
| | | 3 | | 0.000 | | |
| FREE-FORM | CP | 4 | ∞ | 5.000 | 1.51680 | 64.17 |
| FREE-FORM | | 5 | ∞ | 0.000 | | |
| | | 6 | | 0.000 | | |
| | | 7 | | 17.623 | | |
| G3(P) | L16 | 8 | 1121.337 | 11.000 | 1.59282 | 68.62 |
| | | 9 | −89.070 | 0.200 | | |
| | L15 | 10 | 62.685 | 14.011 | 1.49700 | 81.61 |
| | | 11 | −85.735 | 1.785 | | |
| | L14 | 12 | −74.168 | 2.200 | 1.51823 | 58.90 |
| | | 13 | 42.783 | 13.651 | | |
| | L13 | 14 | 100.062 | 7.589 | 1.59282 | 68.62 |
| | | 15 | −129.539 | 3.153 | | |
| | L12 | 16 | −63.078 | 2.200 | 1.74330 | 49.22 |
| | | 17 | 283.806 | 11.379 | | |
| | L11 | 18 | 192.592 | 11.197 | 1.49700 | 81.61 |
| | | 19 | −55.830 | 28.563 | | |
| | L10 | 20 | 142.787 | 2.200 | 1.67300 | 38.26 |
| | | 21 | 81.771 | 2.143 | | |
| | L9 | 22 | 164.761 | 9.015 | 1.59282 | 68.62 |
| | | 23 | −173.671 | 14.653 | | |
| | ST | 24 | | ZOOM | | |
| | | | | INTERVAL | | |
| G2(N) | L8 | 25 | −1528.618 | 4.238 | 1.61800 | 63.39 |
| | | 26 | −105.129 | 3.760 | | |
| | L7 | 27 | −817.550 | 2.000 | 1.48749 | 70.44 |
| | | 28 | 82.210 | 5.236 | | |
| | L6 | 29 | −55.869 | 2.000 | 1.48749 | 70.44 |
| | | 30 | 107.028 | 4.916 | | |
| | L5 | 31 | −54.881 | 2.000 | 1.48749 | 70.44 |
| | | 32 | −1940.948 | 14.162 | | |
| | L4 | 33 | −2732.800 | 5.842 | 1.59270 | 35.45 |
| | | 34 | −93.947 | ZOOM | | |
| | | | | INTERVAL | | |
| G1(P) | L3 | 35 | 600.232 | 9.841 | 1.49700 | 81.61 |
| | | 36 | −91.868 | 0.200 | | |
| | L2 | 37 | −4062.455 | 4.441 | 1.49700 | 81.61 |
| | | 38 | −239.975 | 4.191 | | |
| | L1 | 39 | −101.549 | 2.900 | 1.59270 | 35.45 |
| | | 40 | −287.649 | 0.000 | | |
| | | 41 | | 9000.000 | | |

| | |
|---|---|
| MAG. SIDE | 0.000 |
| CONJUGATE POINT | |

TABLE 6
Y ECC. DATA

| | | Y ECCENTRICITY AMOUNT [mm] | | | | |
|---|---|---|---|---|---|---|
| SURF. | ECC. | WIDE | WIDE | WIDE | WIDE | WIDE |
| NO. | TYPE | 0 deg. | 10 deg. | 20 deg. | 30 deg. | 40 deg. |
| 3 | NORMAL | 61.878 | 51.911 | 43.273 | 35.702 | 30.435 |
| 4 | D.A.R. | −105.973 | −105.973 | −105.973 | −105.973 | −105.973 |
| 5 | D.A.R. | −112.156 | −112.156 | −112.156 | −112.156 | −112.156 |
| 6 | NORMAL | −61.878 | −51.911 | −43.273 | −35.702 | −30.435 |
| SURF. | ECC. | TELE. | TELE. | TELE. | TELE. | TELE. |
| NO. | TYPE | 0 deg. | 10 deg. | 20 deg. | 30 deg. | 40 deg. |
| 3 | NORMAL | 62.311 | 49.669 | 40.710 | 33.591 | 28.313 |
| 4 | D.A.R. | −105.973 | −105.973 | −105.973 | −105.973 | −105.973 |
| 5 | D.A.R. | −112.156 | −112.156 | −112.156 | −112.156 | −112.156 |
| 6 | NORMAL | −62.311 | −49.669 | −40.710 | −33.591 | −28.313 |

α ROT.

| | | α ROTATION AMOUNT [degree] | | | | |
|---|---|---|---|---|---|---|
| SURF. | ECC. | WIDE | WIDE | WIDE | WIDE | WIDE |
| NO. | TYPE | 0 deg. | 10 deg. | 20 deg. | 30 deg. | 40 deg. |
| 4 | D.A.R. | −21.8 | −21.8 | −21.8 | −21.8 | −21.8 |
| 5 | D.A.R. | −21.8 | −21.8 | −21.8 | −21.8 | −21.8 |
| 41 | NORMAL | 0.0 | 10.0 | 20.0 | 30.0 | 40.0 |
| SURF. | ECC. | TELE. | TELE. | TELE. | TELE. | TELE. |
| NO. | TYPE | 0 deg. | 10 deg. | 20 deg. | 30 deg. | 40 deg. |
| 4 | D.A.R. | −21.8 | −21.8 | −21.8 | −21.8 | −21.8 |
| 5 | D.A.R. | −21.8 | −21.8 | −21.8 | −21.8 | −21.8 |
| 41 | NORMAL | 0.0 | 10.0 | 20.0 | 30.0 | 40.0 |

TABLE 7
INTERVAL DATA

| SURF. | WIDE | WIDE | WIDE | WIDE | WIDE |
|---|---|---|---|---|---|
| NO. | 0 deg. | 10 deg. | 20 deg. | 30 deg. | 40 deg. |
| 2 | 6.581 | 6.577 | 6.560 | 6.529 | 6.472 |
| 24 | 41.653 | 41.653 | 41.653 | 41.653 | 41.653 |
| 34 | 2.000 | 2.000 | 2.000 | 2.000 | 2.000 |
| SURF. | TELE. | TELE. | TELE. | TELE. | TELE. |
| NO. | 0 deg. | 10 deg. | 20 deg. | 30 deg. | 40 deg. |
| 2 | 12.770 | 12.753 | 12.685 | 12.561 | 12.374 |
| 24 | 3.594 | 3.594 | 3.594 | 3.594 | 3.594 |
| 34 | 40.060 | 40.060 | 40.060 | 40.060 | 40.060 |

TABLE 8
FREE-FORM
COEFFICIENTS OF XY POLYNOMINAL

| | X\hat{ }0 | X\hat{ }2 | X\hat{ }4 | X\hat{ }6 | X\hat{ }8 | X\hat{ }10 |
|---|---|---|---|---|---|---|
| S4 | k = 0 | | | | | |
| Y\hat{ }0 | | −4.2936E−03 | −2.7886E−07 | 8.0359E−10 | −1.1317E−12 | 2.8677E−16 |
| Y\hat{ }1 | 1.1858E−02 | 6.9789E−06 | 4.8317E−09 | −3.2602E−11 | 3.4976E−14 | |
| Y\hat{ }2 | −5.2481E−03 | −1.1590E−07 | −5.4838E−11 | 5.1961E−13 | −2.7984E−16 | |
| Y\hat{ }3 | 3.1906E−05 | −2.2966E−09 | 1.4103E−12 | −7.2000E−15 | | |
| Y\hat{ }4 | −4.3591E−07 | 2.7853E−11 | −3.6829E−14 | 5.1320E−17 | | |
| Y\hat{ }5 | 1.8453E−09 | −2.0439E−13 | 5.3898E−16 | | | |
| Y\hat{ }6 | 1.3059E−11 | −1.0709E−14 | −4.0429E−18 | | | |
| Y\hat{ }7 | −2.0200E−13 | 2.0639E−16 | | | | |
| Y\hat{ }8 | −1.5084E−15 | −1.2394E−18 | | | | |
| Y\hat{ }9 | 3.4214E−17 | | | | | |
| Y\hat{ }10 | −1.8531E−19 | | | | | |
| S5 | k = 0 | | | | | |
| Y\hat{ }0 | | −3.9510E−03 | −2.1451E−07 | 4.8021E−10 | −8.5778E−13 | 1.2631E−16 |
| Y\hat{ }1 | 3.1412E−02 | 2.5508E−06 | 2.9401E−09 | −1.1218E−11 | 2.5917E−14 | |
| Y\hat{ }2 | −4.3899E−03 | −2.7581E−08 | −1.4496E−11 | 1.3141E−14 | −1.8927E−16 | |
| Y\hat{ }3 | 7.9932E−06 | −1.7237E−10 | −2.8357E−13 | −7.7184E−16 | | |
| Y\hat{ }4 | 1.1203E−08 | −3.0281E−11 | 1.4334E−14 | 1.4787E−17 | | |
| Y\hat{ }5 | −1.0750E−09 | −1.6331E−15 | −1.6075E−16 | | | |
| Y\hat{ }6 | −3.4557E−12 | 4.3615E−15 | 2.1719E−20 | | | |
| Y\hat{ }7 | 7.7328E−14 | −3.1740E−17 | | | | |
| Y\hat{ }8 | 4.2908E−16 | −2.8035E−20 | | | | |
| Y\hat{ }9 | −9.9185E−18 | | | | | |
| Y\hat{ }10 | 2.2901E−20 | | | | | |

### Numerical Example 3

Regarding the optical system of Numerical Example 3 (corresponding to Example 3), Table 9 shows lens data, Table 10 shows Y eccentricity amounts and a rotation amounts of the tilt correction plate. Table 11 shows lens intervals during zooming operation. Table 12 shows free-form surface shape data of the tilt correction plate.

TABLE 9

| | | | | SURFACE | | ABBE |
|---|---|---|---|---|---|---|
| | | | ROC | INTERVAL | R.I. | NO. |
| REDUC. SIDE | | | | 3.000 | | |
| CONJUGATE POINT | | | | | | |
| | P | 1 | | 85.000 | 1.51680 | 64.20 |
| | | 2 | | ZOOM | | |
| | | | | INTERVAL | | |
| | | 3 | | 0.000 | | |
| FREE-FORM | CP | 4 | ∞ | 4.410 | 1.51680 | 64.17 |
| FREE-FORM | | 5 | ∞ | 0.000 | | |
| | | 6 | | 0.000 | | |
| | | 7 | | 6.754 | | |
| G3(P) | L18 | 8 | 123.141 | 9.544 | 1.45860 | 90.19 |
| | | 9 | −100.827 | 0.200 | | |
| | L17 | 10 | 130.871 | 2.200 | 1.73800 | 32.33 |
| | | 11 | 65.972 | 1.494 | | |
| | L16 | 12 | 78.906 | 11.038 | 1.43700 | 95.10 |
| | | 13 | −89.187 | 1.546 | | |
| | L15 | 14 | −71.202 | 2.200 | 1.83481 | 42.74 |
| | | 15 | 214.050 | 0.713 | | |
| | L14 | 16 | 134.620 | 9.140 | 1.45860 | 90.19 |
| | | 17 | −89.943 | 2.472 | | |
| | L13 | 18 | 121.751 | 5.125 | 1.59270 | 35.45 |
| | | 19 | −1006.824 | 66.071 | | |
| | L12 | 20 | 169.815 | 4.223 | 1.59270 | 35.45 |
| | | 21 | −125.796 | 2.441 | | |
| | L11 | 22 | −93.680 | 2.000 | 1.48749 | 70.24 |
| | | 23 | 76.875 | 2.616 | | |
| | ST | 24 | | ZOOM | | |
| | | | | INTERVAL | | |
| G2(P) | L10 | 25 | 182.876 | 6.517 | 1.49700 | 81.61 |
| | | 26 | −79.877 | 0.715 | | |
| | L9 | 27 | −79.818 | 2.200 | 1.57501 | 41.50 |
| | | 28 | −249.776 | 36.177 | | |
| | L8 | 29 | 2909.847 | 2.005 | 1.49700 | 81.61 |
| | | 30 | ∞ | ZOOM | | |
| | | | | INTERVAL | | |
| G1(N) | L7 | 31 | 61.009 | 19.138 | 1.51680 | 64.20 |
| | | 32 | −172.835 | 7.835 | | |
| | L6 | 33 | −233.867 | 2.500 | 1.49700 | 81.61 |
| | | 34 | 54.925 | 17.780 | | |
| | L5 | 35 | −60.386 | 2.500 | 1.49700 | 81.61 |
| | | 36 | −2965.020 | 13.275 | | |
| | L4 | 37 | −47.962 | 2.800 | 1.72916 | 54.67 |
| | | 38 | −140.730 | 0.200 | | |
| | L3 | 39 | −546.604 | 6.452 | 1.80518 | 25.46 |
| | | 40 | −157.108 | 0.200 | | |
| | L2 | 41 | 2144.498 | 7.023 | 1.80518 | 25.46 |
| | | 42 | −181.973 | 17.865 | | |
| | L1 | 43 | −58.044 | 3.500 | 1.80809 | 22.76 |
| | | 44 | −115.225 | 0.000 | | |
| | | 45 | | ZOOM | | |
| | | | | INTERVAL | | |
| | | 46 | | 4000 | | |

| | |
|---|---|
| MAG. SIDE | 0.000 |
| CONJUGATE POINT | |

TABLE 10
Y ECC. DATA

| | | Y ECCENTRICITY AMOUNT [mm] | | | | |
|---|---|---|---|---|---|---|
| SURF. | ECC. | WIDE | WIDE | WIDE | WIDE | WIDE |
| NO. | TYPE | 0 deg. | 10 deg. | 20 deg. | 30 deg. | 40 deg. |
| 3 | NORMAL | 71.346 | 64.259 | 51.563 | 43.995 | 41.211 |
| 4 | D.A.R. | −41.774 | −41.774 | −41.774 | −41.774 | −41.774 |
| 5 | D.A.R. | −41.283 | −41.283 | −41.283 | −41.283 | −41.283 |
| 6 | NORMAL | −71.346 | −64.259 | −51.563 | −43.995 | −41.211 |
| SURF. | ECC. | TELE. | TELE. | TELE. | TELE. | TELE. |
| NO. | TYPE | 0 deg. | 10 deg. | 20 deg. | 30 deg. | 40 deg. |
| 3 | NORMAL | 74.845 | 64.025 | 54.839 | 48.996 | 46.666 |
| 4 | D.A.R. | −41.774 | −41.774 | −41.774 | −41.774 | −41.774 |
| 5 | D.A.R. | −41.283 | −41.283 | −41.283 | −41.283 | −41.283 |
| 6 | NORMAL | −74.845 | −64.025 | −54.839 | −48.996 | −46.666 |

α ROT.

| | | α ROTATION AMOUNT [degree] | | | | |
|---|---|---|---|---|---|---|
| SURF. | ECC. | WIDE | WIDE | WIDE | WIDE | WIDE |
| NO. | TYPE | 0 deg. | 10 deg. | 20 deg. | 30 deg. | 40 deg. |
| 4 | D.A.R. | 57.6 | 57.6 | 57.6 | 57.6 | 57.6 |
| 5 | D.A.R. | 57.6 | 57.6 | 57.6 | 57.6 | 57.6 |
| 45 | NORMAL | 0.0 | 10.0 | 20.0 | 30.0 | 40.0 |
| SURF. | ECC. | TELE. | TELE. | TELE. | TELE. | TELE. |
| NO. | TYPE | 0 deg. | 10 deg. | 20 deg. | 30 deg. | 40 deg. |
| 4 | D.A.R. | 57.6 | 57.6 | 57.6 | 57.6 | 57.6 |
| 5 | D.A.R. | 57.6 | 57.6 | 57.6 | 57.6 | 57.6 |
| 45 | NORMAL | 0.0 | 10.0 | 20.0 | 30.0 | 40.0 |

TABLE 11
INTERVAL DATA

| SURF. | WIDE | WIDE | WIDE | WIDE | WIDE |
|---|---|---|---|---|---|
| NO. | 0 deg. | 10 deg. | 20 deg. | 30 deg. | 40 deg. |
| 2 | 18.501 | 18.505 | 18.522 | 18.534 | 18.528 |
| 24 | 2.000 | 2.000 | 2.000 | 2.000 | 2.000 |
| 30 | 107.385 | 107.385 | 107.385 | 107.385 | 107.385 |
| 45 | 2.410 | 2.410 | 2.410 | 2.410 | 2.410 |
| SURF. | TELE. | TELE. | TELE. | TELE. | TELE. |
| NO. | 0 deg. | 10 deg. | 20 deg. | 30 deg. | 40 deg. |
| 2 | 25.066 | 25.069 | 25.078 | 25.078 | 25.059 |
| 24 | 60.076 | 60.076 | 60.076 | 60.076 | 60.076 |
| 30 | 26.675 | 26.675 | 26.675 | 26.675 | 26.675 |
| 45 | 18.537 | 18.537 | 18.537 | 18.537 | 18.537 |

TABLE 12
FREE-FORM
COEFFICIENTS OF XY POLYNOMINAL

| | X\hat{ }0 | X\hat{ }2 | X\hat{ }4 | X\hat{ }6 | X\hat{ }8 | X\hat{ }10 |
|---|---|---|---|---|---|---|
| S4 | k = 0 | | | | | |
| Y\hat{ }0 | | −3.7865E−03 | −5.6849E−08 | −2.5268E−10 | −1.3678E−13 | 5.6633E−16 |
| Y\hat{ }1 | 9.0390E−01 | 1.4154E−05 | −6.4238E−09 | 1.0181E−12 | 1.2162E−14 | |
| Y\hat{ }2 | −6.4193E−03 | −5.8535E−07 | −5.6738E−10 | 9.1058E−13 | 4.1471E−16 | |
| Y\hat{ }3 | 2.5021E−05 | −1.6321E−08 | −2.6165E−12 | 5.1737E−14 | | |
| Y\hat{ }4 | −4.1535E−07 | −4.9454E−10 | 7.2873E−14 | 9.6273E−16 | | |
| Y\hat{ }5 | −1.0413E−08 | 5.4380E−11 | 0.0000E+00 | | | |
| Y\hat{ }6 | −9.2036E−10 | 2.1343E−12 | 0.0000E+00 | | | |
| Y\hat{ }7 | 2.7956E−12 | 1.6805E−14 | | | | |
| Y\hat{ }8 | 1.1673E−12 | −2.1080E−16 | | | | |
| Y\hat{ }9 | 3.4308E−14 | | | | | |
| Y\hat{ }10 | 3.0517E−16 | | | | | |
| S5 | k = 0 | | | | | |
| Y\hat{ }0 | | −3.5802E−03 | −4.4554E−08 | −2.2981E−10 | −7.9241E−14 | 4.1321E−16 |
| Y\hat{ }1 | 9.2029E−01 | 1.3815E−05 | −5.9555E−09 | 1.4883E−12 | 9.4327E−15 | |
| Y\hat{ }2 | −6.1277E−03 | −5.1931E−07 | −5.0895E−10 | 7.8201E−13 | 3.1672E−16 | |
| Y\hat{ }3 | 2.4638E−05 | 1−1.4947E−08 | −8.0716E−13 | 4.0929E−14 | | |
| Y\hat{ }4 | −3.7836E−07 | −4.2975E−10 | 1.6545E−13 | 7.2709E−16 | | |
| Y\hat{ }5 | −1.0145E−08 | 4.8978E−11 | 1.5880E−15 | | | |
| Y\hat{ }6 | −8.3135E−10 | 1.8891E−12 | 9.5592E−18 | | | |
| Y\hat{ }7 | 3.6641E−12 | 1.4296E−14 | | | | |
| Y\hat{ }8 | 1.0703E−12 | −1.8208E−16 | | | | |
| Y\hat{ }9 | 3.0222E−14 | | | | | |
| Y\hat{ }10 | 2.6406E−16 | | | | | |

### Numerical Example 4

Regarding the optical system of Numerical Example 4 (corresponding to Example 4), Table 13 shows lens data, Table 14 shows Y eccentricity amounts and a rotation amounts of the tilt correction plate. Table 15 shows lens intervals during zooming operation. Table 16 shows free-form surface shape data of the tilt correction plate.

TABLE 13

| | | | | SURFACE | | ABBE |
|---|---|---|---|---|---|---|
| | | | ROC | INTERVAL | R.I. | NO. |
| REDUC. SIDE | | | | 3.000 | | |
| CONJUGATE POINT | | | | | | |
| | P | 1 | | 85.000 | 1.51680 | 64.17 |
| | | 2 | | 18.501 | | |
| | | 3 | | 0.000 | | |
| FREE-FORM | CP | 4 | ∞ | 4.410 | 1.51680 | 64.17 |
| FREE-FORM | | 5 | ∞ | 0.000 | | |
| | | 6 | | 0.000 | | |
| | | 7 | | 6.754 | | |
| | L18 | 8 | 123.141 | 9.544 | 1.45860 | 90.19 |
| | | 9 | −100.827 | 0.200 | | |
| | L17 | 10 | 130.871 | 2.200 | 1.73800 | 32.33 |
| | | 11 | 65.972 | 1.494 | | |
| | L16 | 12 | 78.906 | 11.038 | 1.43700 | 95.10 |
| | | 13 | −89.187 | 1.546 | | |
| | L15 | 14 | −71.202 | 2.200 | 1.83481 | 42.74 |
| | | 15 | 214.050 | 0.713 | | |
| | L14 | 16 | 134.620 | 9.140 | 1.45860 | 90.19 |
| | | 17 | −89.943 | 2.472 | | |
| | L13 | 18 | 121.751 | 5.125 | 1.59270 | 35.45 |
| | | 19 | −1006.824 | 66.071 | | |
| | L12 | 20 | 169.815 | 4.223 | 1.59270 | 35.45 |
| | | 21 | −125.796 | 2.441 | | |
| | L11 | 22 | −93.680 | 2.000 | 1.48749 | 70.24 |
| | | 23 | 76.875 | 2.616 | | |
| | ST | 24 | | 2.000 | | |
| | L10 | 25 | 182.876 | 6.517 | 1.49700 | 81.61 |
| | | 26 | −79.877 | 0.715 | | |
| | L9 | 27 | −79.818 | 2.200 | 1.57501 | 41.50 |
| | | 28 | −249.776 | 36.177 | | |
| | L8 | 29 | 2909.847 | 2.005 | 1.49700 | 81.61 |
| | | 30 | ∞ | 107.385 | | |
| | L7 | 31 | 61.009 | 19.138 | 1.51680 | 64.20 |
| | | 32 | −172.835 | 7.835 | | |
| | L6 | 33 | −233.867 | 2.500 | 1.49700 | 81.61 |
| | | 34 | 54.925 | 17.780 | | |
| | L5 | 35 | −60.386 | 2.500 | 1.49700 | 81.61 |
| | | 36 | −2965.020 | 13.275 | | |
| | L4 | 37 | −47.962 | 2.800 | 1.72916 | 54.67 |
| | | 38 | −140.730 | 0.200 | | |
| | L3 | 39 | −546.604 | 6.452 | 1.80518 | 25.46 |
| | | 40 | −157.108 | 0.200 | | |
| | L2 | 41 | 2144.498 | 7.023 | 1.80518 | 25.46 |
| | | 42 | −181.973 | 17.865 | | |
| | L1 | 43 | −58.044 | 3.500 | 1.80809 | 22.76 |
| | | 44 | −115.225 | 0.000 | | |
| | | 45 | | 2.410207171 | | |
| | | 46 | | 4000 | | |

| | |
|---|---|
| MAG. SIDE | 0.000 |
| CONJUGATE POINT | |

TABLE 14

| Y ECC. | | Y ECC. |
|---|---|---|
| DATA | | AMOUNT [mm] |
| SURF. NO. | ECC. TYPE | 40 deg. |
| 3 | NORMAL | −71.839 |
| 4 | D.A.R. | 102.604 |
| 5 | D.A.R. | 92.678 |
| 6 | NORMAL | 71.839 |
| | | α ROTATION |
| α ROT. | | AMOUNT [deg.] |
| SURF. NO. | ECC. TYPE | 40 deg. |
| 4 | D.A.R. | 8.1 |
| 5 | D.A.R. | 8.1 |
| 45 | NORMAL | 40.0 |

TABLE 15
FREE-FORM
COEFFICIENTS OF XY POLYNOMINAL

| | X\hat{ }0 | X\hat{ }2 | X\hat{ }4 | X\hat{ }6 | X\hat{ }8 | X\hat{ }10 |
|---|---|---|---|---|---|---|
| S4 | k = 0 | | | | | |
| Y\hat{ }0 | | −8.0137E−03 | 8.9989E−07 | 1.9948E−09 | 5.5923E−12 | −3.3358E−17 |
| Y\hat{ }1 | −3.2139E−01 | 1.7689E−04 | 3.0759E−07 | 4.5584E−10 | 3.2190E−13 | |
| Y\hat{ }2 | −9.9481E−04 | 1.6354E−05 | 3.0836E−08 | 2.6339E−11 | 4.8762E−15 | |
| Y\hat{ }3 | 4.2900E−06 | 6.0148E−07 | 1.5244E−09 | 5.9606E−13 | | |
| Y\hat{ }4 | 2.1189E−06 | 9.4483E−09 | 3.9741E−11 | 4.5667E−15 | | |
| Y\hat{ }5 | 4.3235E−08 | 8.7993E−12 | 5.1819E−13 | | | |
| Y\hat{ }6 | −4.4698E−10 | −1.4849E−12 | 2.6517E−15 | | | |
| Y\hat{ }7 | −2.3171E−11\| | −1.4192E−14 | | | | |
| Y\hat{ }8 | −1.9410E−13 | −2.4773E−17 | | | | |
| Y\hat{ }9 | 8.6460E−16 | | | | | |
| Y\hat{ }10 | 1.3098E−17 | | | | | |
| S5 | k = 0 | | | | | |
| Y\hat{ }0 | | −7.5731E−03 | −9.3823E−08 | −4.2535E−10 | 1.7442E−12 | −5.6787E−17 |
| Y\hat{ }1 | −2.8166E−01 | −3.7232E−06 | 7.0822E−09 | 4.2676E−11 | 1.3699E−13 | |
| Y\hat{ }2 | 1.4991E−04 | 2.3627E−06 | 1.9413E−09 | 6.6155E−12 | 3.1823E−15 | |
| Y\hat{ }3 | −2.5401E−05 | 1.7759E−07 | 2.1042E−10 | 2.7289E−13 | | |
| Y\hat{ }4 | 2.1716E−07 | 5.0620E−09 | 1.0646E−11 | 3.2509E−15 | | |
| Y\hat{ }5 | 5.5192E−08 | 3.6511E−11 | 2.3653E−13 | | | |
| Y\hat{ }6 | 1.9271E−09 | −8.7205E−13 | 1.8788E−15 | | | |
| Y\hat{ }7 | 3.6868E−11 | −1.4468E−14 | | | | |
| Y\hat{ }8 | 5.5489E−13 | −3.3300E−17 | | | | |
| Y\hat{ }9 | 6.9971E−15 | | | | | |
| Y\hat{ }10 | 4.4302E−17 | | | | | |

Table 16 below shows the corresponding values of the respective conditional expressions (10), (11A) and (11B) in the respective Numerical Examples 1 to 4.

TABLE 16

| WIDE | | pa | pb | pb − pa | α1A | α1B | α1A − α1B | α2A | α2B | α2A − α2B |
|---|---|---|---|---|---|---|---|---|---|---|
| EX. 1 | 40 | −0.00046 | −0.00016 | 0.000307 | 22.6 | 9.7 | 12.9 | 20.5 | 9.2 | 11.4 |
| | 30 | −0.00040 | −0.00013 | 0.000267 | 18.9 | 7.8 | 11.1 | 17.4 | 7.4 | 10.0 |
| | 20 | −0.00028 | −0.00011 | 0.000170 | 14.7 | 5.4 | 9.3 | 13.7 | 5.2 | 8.6 |
| | 10 | −0.00010 | −0.00008 | 0.000024 | 4.8 | −1.9 | 6.7 | 4.6 | −1.8 | 6.4 |
| EX. 2 | 40 | −0.00059 | −0.00027 | 0.000322 | 21.3 | 6.4 | 14.9 | 18.9 | 5.7 | 13.2 |
| | 30 | −0.00051 | −0.00024 | 0.000264 | 17.4 | 3.8 | 13.5 | 15.5 | 3.3 | 12.2 |
| | 20 | −0.00039 | −0.00022 | 0.000168 | 12.5 | 0.4 | 12.1 | 11.2 | 0.1 | 11.1 |
| | 10 | −0.00029 | −0.00021 | 0.000083 | 7.7 | −3.4 | 11.1 | 6.9 | −3.4 | 10.3 |
| EX. 3 | 40 | −0.00009 | −0.00007 | 0.000018 | 34.2 | 29.7 | 4.4 | 33.5 | 29.3 | 4.2 |
| | 30 | −0.00008 | −0.00007 | 0.000011 | 33.3 | 28.8 | 4.5 | 32.7 | 28.4 | 4.3 |
| | 20 | −0.00007 | −0.00007 | 0.000000 | 30.9 | 26.0 | 4.9 | 30.4 | 25.7 | 4.6 |
| | 10 | −0.00007 | −0.00011 | −0.000039 | 26.5 | 20.2 | 6.3 | 26.2 | 20.2 | 6.0 |
| EX. 4 | 40 | −0.00025 | −0.00008 | 0.000167 | 25.0 | 26.2 | −1.2 | 24.0 | 25.6 | −1.6 |
| TELE. | | pa | pb | pb − pa | α1A | α1B | α1A − α1B | α2A | α2B | α2A − α2B |
| EX. 1 | 40 | −0.00045 | −0.00019 | 0.000255 | 26.4 | 11.6 | 14.8 | 23.8 | 10.9 | 12.9 |
| | 30 | −0.00046 | −0.00016 | 0.000306 | 22.3 | 9.6 | 12.8 | 20.3 | 9.1 | 11.3 |
| | 20 | −0.00034 | −0.00012 | 0.000222 | 16.8 | 6.7 | 10.2 | 15.6 | 6.3 | 9.3 |
| | 10 | −0.00015 | −0.00008 | 0.000066 | 9.2 | 1.7 | 7.6 | 8.7 | 1.6 | 7.1 |
| EX. 2 | 40 | −0.00062 | −0.00029 | 0.000334 | 23.0 | 7.4 | 15.6 | 20.4 | 6.7 | 13.7 |
| | 30 | −0.00054 | −0.00025 | 0.000290 | 18.9 | 4.8 | 14.1 | 16.9 | 4.3 | 12.6 |
| | 20 | −0.00042 | −0.00022 | 0.000199 | 14.0 | 1.5 | 12.5 | 12.6 | 1.2 | 11.4 |
| | 10 | −0.00031 | −0.00021 | 0.000102 | 8.9 | −2.4 | 11.3 | 8.0 | −2.5 | 10.5 |
| EX. 3 | 40 | −0.00008 | −0.00007 | 0.000007 | 32.5 | 27.8 | 4.6 | 31.9 | 27.5 | 4.4 |
| | 30 | −0.00007 | −0.00007 | 0.000004 | 31.7 | 27.0 | 4.7 | 31.2 | 26.7 | 4.5 |
| | 20 | −0.00007 | −0.00008 | −0.000006 | 29.8 | 24.7 | 5.1 | 29.4 | 24.5 | 4.9 |
| | 10 | −0.00007 | −0.00011 | −0.000038 | 26.6 | 20.3 | 6.2 | 26.3 | 20.3 | 6.0 |

Table 17 below shows the corresponding values of the respective conditional expressions (20) and (22) in the respective Numerical Examples 1 to 4.

TABLE 17

| WIDE | | px | py | py − px | αo1 | αo2 | αo1 − αo2 |
|---|---|---|---|---|---|---|---|
| EX. 1 | 40 | −0.00038 | −0.00028 | 0.00010 | 15.0 | 14.0 | 1.0 |
| | 30 | −0.00031 | −0.00021 | 0.00009 | 12.5 | 11.7 | 0.8 |
| | 20 | −0.00025 | −0.00015 | 0.00009 | 9.5 | 9.0 | 0.5 |
| | 10 | −0.00016 | −0.00008 | 0.00008 | 1.3 | 1.3 | 0.1 |
| EX. 2 | 40 | −0.00053 | −0.00040 | 0.00013 | 12.9 | 11.7 | 1.3 |
| | 30 | −0.00046 | −0.00033 | 0.00013 | 9.9 | 8.9 | 1.0 |
| | 20 | −0.00039 | −0.00027 | 0.00012 | 6.0 | 5.3 | 0.6 |
| | 10 | −0.00034 | −0.00023 | 0.00012 | 1.9 | 1.5 | 0.3 |
| EX. 3 | 40 | −0.00021 | −0.00007 | 0.00013 | 32.0 | 31.4 | 0.6 |
| | 30 | −0.00021 | −0.00007 | 0.00013 | 31.1 | 30.6 | 0.5 |
| | 20 | −0.00021 | −0.00007 | 0.00014 | 28.6 | 28.2 | 0.4 |
| | 10 | −0.00024 | −0.00008 | 0.00016 | 23.7 | 23.5 | 0.2 |
| EX. 4 | 40 | −0.00089 | −0.00011 | 0.00078 | 25.7 | 25.0 | 0.7 |

| TELE. | | px | py | py − px | α1 | α2 | αo1− αo2 |
|---|---|---|---|---|---|---|---|
| EX. 1 | 40 | −0.00050 | −0.00036 | 0.00013 | 17.6 | 16.3 | 1.3 |
| | 30 | −0.00038 | −0.00028 | 0.00010 | 14.8 | 13.8 | 1.0 |
| | 20 | −0.00027 | −0.00018 | 0.00009 | 11.0 | 10.4 | 0.6 |
| | 10 | −0.00019 | −0.00010 | 0.00009 | 5.2 | 4.9 | 0.3 |
| EX. 2 | 40 | −0.00057 | −0.00043 | 0.00014 | 14.3 | 12.8 | 1.4 |
| | 30 | −0.00048 | −0.00035 | 0.00013 | 11.1 | 10.0 | 1.1 |
| | 20 | −0.00041 | −0.00029 | 0.00012 | 7.2 | 6.5 | 0.7 |
| | 10 | −0.00035 | −0.00023 | 0.00012 | 2.9 | 2.5 | 0.4 |
| EX. 3 | 40 | −0.00021 | −0.00007 | 0.00014 | 30.2 | 29.7 | 0.5 |
| | 30 | −0.00021 | −0.00007 | 0.00014 | 29.4 | 29.0 | 0.4 |
| | 20 | −0.00022 | −0.00007 | 0.00015 | 27.4 | 27.0 | 0.4 |
| | 10 | −0.00024 | −0.00008 | 0.00016 | 23.8 | 23.6 | 0.2 |

### Second Embodiment

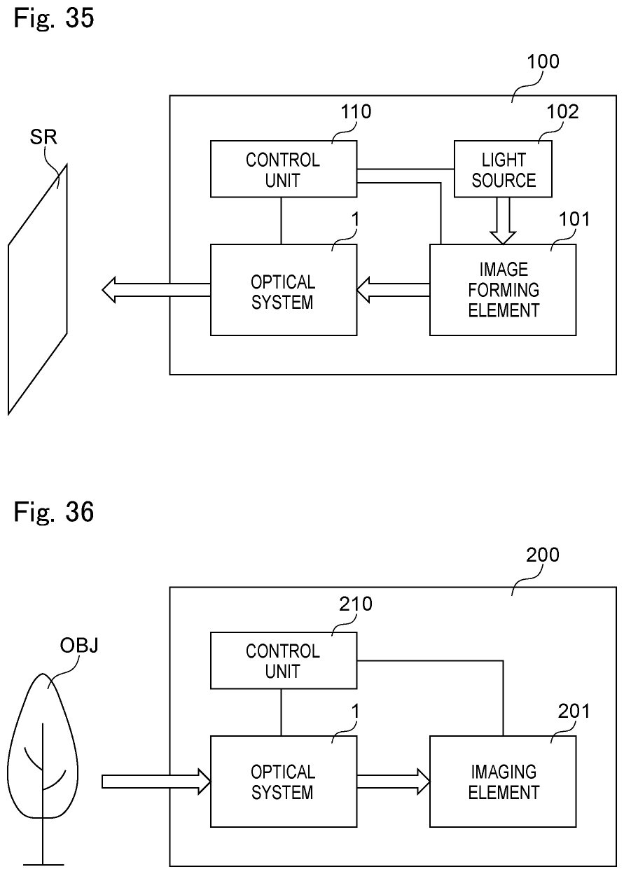

Hereinafter, second embodiment of the present disclosure is described with reference to FIG. 35. FIG. 35 is a block diagram showing an example of the image projection apparatus according to the present disclosure. The image projection apparatus 100 includes such an optical system 1 as disclosed in First Embodiment, an image forming element 101, a light source 102, a control unit 110, and others. The image forming element 101 is constituted of, for example, liquid crystal or DMD, for generating an image to be projected through the optical system 1 onto a screen SR. The light source 102 is constituted of, for example, light emitting diode (LED) or laser, for supplying light to the image forming element 101. The control unit 110 is constituted of, for example, central processing unit (CPU) or micro-processing unit (MPU), for controlling the entire apparatus and respective components. The optical system 1 may be configured as either an interchangeable lens that can be detachably attached to the image projection apparatus 100 or a built-in lens that is integrated in the image projection apparatus 100.

The image projection apparatus 100 including the optical system according to First Embodiment can realize projection with a shorter focal length and a larger-sized screen.

### Third Embodiment

Hereinafter, a third embodiment of the present disclosure is described with reference to FIG. 36. FIG. 36 is a block diagram showing an example of the imaging apparatus according to the present disclosure. The imaging apparatus 200 includes such an optical system 1 as disclosed in First Embodiment, an imaging element 201, a control unit 210, and others. The imaging element 201 is constituted of, for example, charge coupled device (CCD) image sensor or complementary metal oxide semiconductor (CMOS) image sensor, for receiving an optical image of an object OBJ formed by the optical system 1 to convert the image into an electrical image signal. The control unit 110 is constituted of, for example, CPU or MPU, for controlling the entire apparatus and respective components. The optical system 1 may be configured as either an interchangeable lens that can be detachably attached to the imaging apparatus 200 or a built-in lens that is integrated in the imaging apparatus 200.

The imaging apparatus 200 including the optical system according to First Embodiment can realize imaging with a shorter focal length and a larger-sized screen.

As described above, the embodiments have been described to disclose the technology in the present disclosure. To that end, the accompanying drawings and detailed description are provided.

Therefore, among the components described in the accompanying drawings and the detailed description, not only the components that are essential for solving the problem, but also the components that are not essential for solving the problem may also be included in order to exemplify the above-described technology. Therefore, it should not be directly appreciated that the above non-essential components are essential based on the fact that the non-essential components are described in the accompanying drawings and the detailed description.

Further, the above-described embodiments have been described to exemplify the technology in the present disclosure. Thus, various modification, substitution, addition, omission and so on can be made within the scope of the claims or equivalents thereof.

### INDUSTRIAL APPLICABILITY

The present disclosure can be applied to image projection apparatuses such as projectors and head-up displays, and imaging apparatuses such as digital still cameras, digital video cameras, surveillance cameras in surveillance systems, web cameras, and onboard cameras. In particular, the present disclosure can be applied to optical systems that require a high image quality, such as projectors, digital still camera systems, and digital video camera systems.

1. An optical system having a reduction conjugate point on a reduction side and a magnification conjugate point on a magnification side that are optically conjugate with each other, the optical system including an imaging optical system having a plurality of lens elements that are rotationally symmetric with respect to an optical axis, and an aperture stop,
wherein a first rectangular region at the reduction conjugate point and a second rectangular region at the magnification conjugate point have an optically conjugate image forming relation,
a normal line of the second rectangular region is inclined at a tilt angle of 10 degrees or more with respect to the optical axis, and
a tilt correction plate that corrects defocus in the first rectangular region or the second rectangular region is positioned on the reduction side of the aperture stop between the reduction conjugate point and the magnification conjugate point.

2. The optical system according to claim 1, wherein the tilt correction plate is configured to satisfy the following expression (10), where two end points of the first rectangular region in a meridional plane including the normal line and the optical axis are defined as points A and B:
$$pb - pa > 0 \qquad ( 10 )$$
$$pa = ( nd - 1 ) \times ( 1 / ra 1 - 1 / ra 2 ) \qquad ( 10 A )$$
$$pb = ( nd - 1 ) \times ( 1 / rb 1 - 1 / rb 2 ) \qquad ( 10 B )$$
where nd is a refractive index of the tilt correction plate, ra1 is a partial radius of curvature in the meridional plane at a point a1 where a straight line parallel to the optical axis passes through the point A and intersects with the first plane of the tilt correction plate, ra2 is a partial radius of curvature in the meridional plane at a point a2 where a straight line parallel to the optical axis passes through the point A and intersects with the second plane of the tilt correction plate, rb1 is a partial radius of curvature in the meridional plane at a point b1 where a straight line parallel to the optical axis passes through the point B and intersects with the first plane of the tilt correction plate, and rb2 is a partial radius of curvature in the meridional plane at a point b2 where a straight line parallel to the optical axis passes through the point B and intersects with the second surface of the tilt correction plate.

3. The optical system according to claim 1, wherein the tilt correction plate is configured to satisfy the following expressions (11A) and (11B):
$$α 1 A - α 1 B > 0 \qquad ( 11 A )$$
$$α 2 A - α 2 B > 0 \qquad ( 11 B )$$
where α1A is an angle at which a straight line connecting a point a1 (where a straight line parallel to the optical axis passes through the point A and intersects with the first surface of the tilt correction plate) and the center of the partial radius of curvature at the point a1 intersects with the optical axis, α1B is an angle at which a straight line connecting a point b1 (where a straight line parallel to the optical axis passes through the point B and intersects with the first surface of the tilt correction plate) and the center of the partial radius of curvature at the point b1 intersects with the optical axis, α2A is an angle at which a straight line connecting a point a2 (where a straight line parallel to the optical axis passes through the point A and intersects with the second surface of the tilt correction plate) and the center of the partial radius of curvature at the point a2 intersects with the optical axis, and α2B is as an angle at which a straight line connecting a point b2 (where a straight line parallel to the optical axis passes through the point B and intersects with the second surface of the tilt correction plate CP) and the center of the partial radius of curvature at the point b2 intersects with the optical axis.

4. An optical system having a reduction conjugate point on a reduction side and a magnification conjugate point on a magnification side that are optically conjugate with each other, the optical system including an imaging optical system having a plurality of lens elements that are rotationally symmetric with respect to an optical axis,
wherein a first rectangular region at the reduction conjugate point and a second rectangular region at the magnification conjugate point have an optically conjugate image forming relation,
a normal line of the second rectangular region is inclined at a tilt angle of 10 degrees or more with respect to the optical axis,
a tilt correction plate that corrects defocus in the first rectangular region or the second rectangular region is positioned between the reduction conjugate point and the magnification conjugate point,
the tilt correction plate has a first surface having a free-form surface shape on the reduction side and a second surface having a free-form surface shape on the magnification side, and
the tilt correction plate is configured to satisfy the following expressions (11A) and (11B), where two end points of the first rectangular region in a meridional plane including the normal line and the optical axis are defined as points A and B:
$$α 1 A - α 1 B > 0 \qquad ( 11 A )$$
$$α 2 A - α 2 B > 0 \qquad ( 11 B )$$
where α1A is an angle at which a straight line connecting a point a1 (where a straight line parallel to the optical axis passes through the point A and intersects with the first surface of the tilt correction plate) and the center of the partial radius of curvature at the point a1 intersects with the optical axis, α1B is an angle at which a straight line connecting a point b1 (where a straight line parallel to the optical axis passes through the point B and intersects with the first surface of the tilt correction plate) and the center of the partial radius of curvature at the point b1 intersects with the optical axis, α2A is an angle at which a straight line connecting a point a2 (where a straight line parallel to the optical axis passes through the point A and intersects with the second surface of the tilt correction plate) and the center of the partial radius 15 of curvature at the point a2 intersects with the optical axis, and α2B is as an angle at which a straight line connecting a point b2 (where a straight line parallel to the optical axis passes through the point B and intersects with the second surface of the tilt correction plate CP) and the center of the partial radius of curvature at the point b2 intersects with the optical axis.

5. The optical system according to claim 4, wherein the tilt correction plate is configured to satisfy the following expression (10):
$$pb - pa > 0 \qquad ( 10 )$$
$$pa = ( nd - 1 ) \times ( 1 / ra 1 - 1 / ra 2 ) \qquad ( 10 A )$$
$$pb = ( nd - 1 ) \times ( 1 / rb 1 - 1 / rb 2 ) \qquad ( 10 B )$$
where nd is a refractive index of the tilt correction plate, ra1 is a partial radius of curvature in the meridional plane at a point a1 where a straight line parallel to the optical axis passes through the point A and intersects with the first plane of the tilt correction plate, ra2 is a partial radius of curvature in the meridional plane at a point a2 where a straight line parallel to the optical axis passes through the point A and intersects with the second plane of the tilt correction plate, rb1 is a partial radius of curvature in the meridional plane at a point b1 where a straight line parallel to the optical axis passes through the point B and intersects with the first plane of the tilt correction plate, and rb2 is a partial radius of curvature in the meridional plane at a point b2 where a straight line parallel to the optical axis passes through the point B and intersects with the second surface of the tilt correction plate.

6. The optical system according to claim 2, wherein the tilt correction plate is configured to satisfy the following expressions (20), (21), and (22), where a point at which the optical axis intersects with the first rectangular region is defined as a point O:
$$py - px > 0 \qquad ( 20 )$$
$$px = ( nd - 1 ) \times ( 1 / rxo 1 - 1 / rxo 2 ) \qquad ( 20 A )$$
$$py = ( nd - 1 ) \times ( 1 / ryo 1 - 1 / ryo 2 ) \qquad ( 20 B )$$
$$α o 1 < 0 \qquad ( 21 )$$
$$α o 1 - α o 2 > 0 \qquad ( 22 )$$
where nd is a refractive index of the tilt correction plate, rxo1 is a partial radius of curvature in a plane perpendicular to the meridional plane at a point o1 where the optical axis passes through the point O and intersects with the first plane of the tilt correction plate, rxo2 is a partial radius of curvature in a plane perpendicular to the meridional plane at a point O2 where the optical axis passes through the point O and intersects with the second plane of the tilt correction plate, ryo1 is a partial radius of curvature in the meridional plane at a point o1 where the optical axis passes through the point O and intersects with the first plane of the tilt correction plate, ryo2 is a partial radius of curvature in the meridional plane at a point o2 where the optical axis passes through the point O and intersects with the second plane of the tilt correction plate, αo1 is an angle at which a straight line connecting a point o1 (at which the optical axis passes through the point O and intersects with the first surface of the tilt correction plate) and the center of the partial radius of curvature at the point o1 intersects with the optical axis, and αo2 is an angle at which a straight line connecting a point o2 (at which the optical axis passes through the point O and intersects with the second surface of the tilt correction plate) and the center of the partial radius of curvature at the point o2 intersects with the optical axis.

7. The optical system according to claim 1, wherein the partial curvature radius at an arbitrary point on the free-form surface is defined by the radius of a circle passing through three points on the free-form surface: a middle point on the free-form surface, an upper point on the free-form surface separated from the middle point by the distance of +0.001 mm to +0.100 mm in a direction perpendicular to the optical axis, and a lower point on the free-form surface separated from the middle point by the distance of −0.001 mm to −0.100 mm in a direction perpendicular to the optical axis.

8. The optical system according to claim 6, wherein the tilt correction plate is configured to satisfy the following expression (31):
$$- 0.0005 < py < 0. . \qquad ( 31 )$$

9. The optical system according to claim 6, wherein the tilt correction plate is configured to satisfy the following expression (32):
$$- 0.001 < px < 0. . \qquad ( 32 )$$

10. The optical system according to claim 2, wherein the tilt correction plate is configured to satisfy the following expression (33):
$$pb - pa < 0.0005 . \qquad ( 33 )$$

11. The optical system according to claim 6, wherein the tilt correction plate is configured to satisfy the following expression (34):
$$py - px < 0.001 . \qquad ( 34 )$$

12. The optical system according to claim 6, wherein the tilt correction plate is configured to satisfy the following expression (35):
$$α o 1 - α o 2 < 1.5 . \qquad ( 35 )$$

13. The optical system according to claim 3, wherein the tilt correction plate is configured to satisfy the following expression (36):
$$α 1 A - α 1 B < 20. \qquad ( 36 )$$

14. The optical system according to claim 3, wherein the tilt correction plate is configured to satisfy the following expression (37):
$$α 2 A - α 2 B < 15. \qquad ( 37 )$$

15. The optical system according to claim 2, wherein the tilt correction plate is positioned between the reduction conjugate point and the imaging optical system.

16. The optical system according to claim 1, wherein the tilt correction plate can be displaced in a direction intersecting with the optical axis when the tilt angle is changed.

17. An image projection apparatus comprising:
the optical system according to claim 1; and
an image forming element that generates an image to be projected through the optical system onto a screen.

18. An imaging apparatus comprising:
the optical system according to claim 1; and
an imaging element that receives an optical image formed by the optical system to convert the optical image into an electrical image signal.
